(19) United States
(12) Patent Application Publication
(10) Pub. No.: US 2010/0070320 A1
(43) Pub. Date: Mar. 18, 2010

(54) ACCOUNTING TOOL FOR MEASURING ECOSYSTEM SERVICE FUNCTIONAL PERFORMANCE AT A PARTICULAR SITE

(75) Inventors: Michelle Kenna HALSEY, Portland, OR (US); Kevin P. Halsey, Portland, OR (US); Kevin M. Benck, Scappoose, OR (US)

Correspondence Address: KATHLEEN T. PETRICH, GRAHAM & DUNN PC, 2801 ALASKAN WAY, SUITE 300 - PIER 70, SEATTLE, WA, 98121-1128, US

(73) Assignee: Parametrix, Inc.

(21) Appl. No.: 12/557,349

(22) Filed: Sep. 10, 2009

Related U.S. Application Data
(60) Provisional application No. 61/192,188, filed on Sep. 15, 2008.

(51) Int. Cl. G06Q 10/00; G06Q 50/00; G06Q 40/00

(52) U.S. Cl. 705/7; 705/30

(57) ABSTRACT

An accounting method to measure ecological value (or measurement of functional performance) of a particular site that divides the site into individual map units as determined by the number of substantially homogenous habitats found at the site. Habitat functions are determined per individual map unit. Performance indicators, such as habitat structures, physical and biological features, and other components, are identified and collected according to predefined ranges in the field or from actual site data. The values of performance indicators are assessed or scored based on collected data using look-up tables to create an indicator of functional performance. The indicator of functional performance is inputted into formulas to derive a measurement of functional performance at the individual map unit and the overall site. The accounting method of the present invention can also calculate ecological change at a particular site by calculating initial or baseline site values and a projected future value based on a particular projected modification (e.g., restoration or development) at the site and effects the modification may have over a period of time (e.g., 20 years). The difference between the future and the baseline values, whether a credit (uplift) or debit (impact or site degradation), can then be used in diverse applications, such as mitigation banking, ecological exchanges, registries, or as part of business or government decision/policy making.

### RELATED APPLICATION

The present application claims priority to U.S. Provisional Patent Application Ser. No. 61/192,188, filed on Sep. 15, 2008, and entitled “Accounting Tool for Measuring Ecosystem Service Functional Performance at a Particular Site.”

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNICAL FIELD

The present invention relates generally to an accounting tool for measuring the functional performance of a site, and additionally, the benefits and impacts that result from changing ecological conditions by restoring, preserving, or developing the site.

### BACKGROUND OF THE INVENTION

Ecosystem services are the societal benefits that result from nature's performance of functions. For example, a grassy meadow may filter storm water runoff, which results in cleaner water. The same meadow may also store water to help attenuate flood events or aid in aquifer recharge, which provides hazard mitigation and water supply protection respectively. These services can be negatively affected by development, e.g., degradation of wildlife habitat as a result of wetland fill, and also positively affected through conservation-based resource management, e.g., wetland restoration resulting in improved water quality and floodplain restoration resulting in increased flood storage capacity and natural hazard mitigation, etc.

Ecosystem marketplaces basically function as a network of voluntary offset and mitigation solutions, effectively connecting entities wanting or needing to offset impacts with entities doing restoration projects. Often, the entity seeking the impact offset has a mitigation obligation pursuant to regulation, e.g., Endangered Species Act (“ESA”), Clean Water Act (“CWA”), or it may desire to off-set ecosystem impacts voluntarily to meet a green building or other ecological ethic. Land owners whose restoration activities have been certified by the market can sell “credits” to those seeking the offset. Once regulatory structures are in place, the marketplace functions as a trading forum for those who have natural resources and those who need, or otherwise desire, to provide environmental benefits. The marketplace is also available to organizations seeking to offset impacts through the use of cap and trade programs.

After completing an approved transaction within the ecosystem service marketplace (or greater context if one is developed), a developer of a particular site is able to proceed with a development project with a level of assurance that mitigation obligation objectives have been met. This process provides numerous efficiencies for developers, utilities, local jurisdictions, transportation departments, amongst others, because the simple purchase of credits, rather than performing project-by-project mitigation, removes mitigation from the critical path for project delivery. Perhaps, most significantly, such an approach provides incentives to landowners to engage in ecologically meaningful restoration projects in order to generate high quality credits.

The success of such an ecosystem marketplace hinges on a highly credible and transparent accounting system or tool that effectively measures baseline ecological conditions and the impact (positive or negative) resulting from a project. Known tools created to assess ecological value, or “habitat value” rely on the potential for particular species to use a given habitat type. The numerous assumptions that go into this type of approach, and the inability to measure direct changes to habitat formation processes, make it unsuitable for measuring specific, incremental benefits or detriments to a functioning ecosystem. Such a system can provide a sense of the habitats present on a site, but it is not possible to measure fine changes, such as those resulting from enhancement, beyond creation or destruction of the habitat. This lack of fine resolution makes it impossible to use the technique for development of debits and credits that are based on very specific units of trade—and, in turn, that are must be quantifiable and reproducible.

For years now, it has been possible to assess the quality of a wetland, the quality of endangered species habitat, the quality of water in our streams, etc. These measurements are made using a wide variety of metrics and are relevant in several contexts, including regulatory processes, site design decision making, and credit exchanges in the evolving “Ecosystem Marketplace.” In regulated circumstances, these units of measure are generally defined by the regulatory agency with jurisdiction over the resource in question. For example, the US Army Corps of Engineers (USACOE) measures impacts to wetlands in acres and requires mitigation for wetland impacts in acres. At the same time, the Oregon Department of Environmental Quality (ODEQ) measures impacts to stream temperatures using kilocalories (heat) discharged per day from wastewater treatment facilities and allows offsets in the form of kilocalories (solar radiation) blocked per day as the result of planting trees that shade streams. Currently, impacts are evaluated based on specific regulated resources in a siloed regulatory environment with little consideration given to the effect on other valuable resources not regulated by the permitting agency or on the same resource regulated in a different context by another agency. Often, multiple sets of design criteria are applied to a given project simply because the agencies use a different language in an attempt to regulate a given resource. In these situations, the existence of a common accounting currency can greatly improve the project delivery process and result in higher quality environmental resource management because coordinated strategies can be implemented.

What is still absent in known accounting tools is how to assess the baseline condition of a property and account for the effect of multiple types of impacts or benefits to multiple types of resources, using a holistic and integrated ecosystem performance metric. The ability to use one measurement system to address multiple types of resources is pivotal to encouraging impact minimization, high quality restoration, creating a robust ecosystem marketplace, ensuring that an individual unit of benefit (credit) can be sold in one of many markets—but cannot be sold in more than one market or to offset multiple projects, and improving our ability to truly understand the effects of our actions upon the ecosystem.

For example, when impacts to a wetland are measured in only terms of acres of wetland lost, the associated negative impacts on the broad array of ecosystem services and habitat functions affected by the loss of the wetland are not captured directly by the simple acreage measurement. Indeed, the acreage metric is a surrogate used because of the lack of a metric capable of measuring functional value—it is often assumed that bigger is better.

Consider wetlands as an example habitat for which impacts and restoration benefits have not been well defined using traditional approaches. Functions performed by wetlands include water filtration, groundwater recharge, flood flow attenuation, and provision of fish, wildlife, and rare plant habitat. A simple metric of wetland acreage lost does not capture the myriad of benefits truly lost with that wetlands. Similarly, the benefits of restoring an acre of wetland extend far beyond the regulatory mandate of no net loss of wetland acres. Additional benefits that may result from wetland restoration include improved water quality, groundwater recharge, attenuation of flood flows, and provision of important habitat for plants, fish, and wildlife.

There has not been a reliable ecological accounting tool by which to quantify the fact that a small, highly functioning wetland can be worth more ecologically than a large wetland of moderate quality. Thus under currently regulatory schemes, the values under commonly known accounting tools can lead to a ludicrous result of encouraging impacts to higher quality, smaller wetlands than larger wetlands of little to moderate value. Similarly, when quality is considered in the regulatory permitting process, it is also based on assumptions about the value of a habitat that may, or may not, be truly accurate. For example, it is commonly accepted in the regulatory community that a forested wetland is intuitively more valuable than an emergent wetland. However, given a particular landscape context with water quality concerns, an emergent wetland may perform more, highly valuable functions related to water quality than a particular forested wetlands.

Also lacking in current approaches is a means to weight the value of a habitat type or habitat functions in a single metric that is based on the restoration priorities, recovery goals, or local land use ordinances designed to protect habitats of unique significance to a particular part of the country. The lack of a single metric that can be identified as a credit or a debit encompassing vast habitat functions makes voluntary marketplace activities untenable as there would be no easy way to compare credit and debit values to each other.

### SUMMARY OF THE INVENTION

The guiding principle of this invention is that ecological condition, impacts and benefits to habitat functions are captured so that informed project design decisions can be made. When an ecological condition effect can be known and quantified, the resulting value can be utilized in the ecosystem marketplace or in databases, particularly in the voluntary market, or as a basis for regulatory and policy decisions. When the effects of impact and benefit are known, it also becomes possible to more accurately determine the debit or credit that a land owner should receive for developing/restoring/preserving a property or site. This is pivotal to achieving high quality restoration because it provides incentives for landowners to create as much benefit from a restoration project as possible. A landowner investing in restoring wetland hydrology and planting wetland species can get wetland credits to sell in an ecosystem marketplace, but if he also plants trees that shade a stream, he may also be able to generate temperature credits from the same, or slightly larger, level of investment in his project. Basically, the more beneficial the restoration, the greater number of credits generated and the more types of markets are available to the landowner—which results in a higher rate of return for the landowner and a more meaningful restoration project.

This invention is directed to breaking a given site down into physical (abiotic) and biological (biotic) habitat functions that are analyzed and accorded functional performance measurements. Each portion of the site is demarcated within substantially homogeneous map units based on habitat type. Information is collected through a field survey on the physical and biological performance indicators (PI) present within the map units. Data is collected for each PI according to defined quantitative and/or qualitative ranges. The ranges for each PI correlate to predefined lookup tables are used in the calculation of the performance value (FP) for each function. For any given function, the condition of each PI determines the values taken from the lookup table to be used in the FP equation. For each function, a performance value (FP) is calculated for a map unit by adding the various PI values from the lookup tables, for that map unit, and dividing the sum by the number of PI(s).

An overall functional performance (FP′) for the map unit is derived equally from the contributions of the abiotic and biotic functions, unless otherwise weighted. The functional performance for abiotic functions (FP_{A}) is determined by averaging the abiotic functions performed by the PI(s) within the map unit. The functional performance for the biotic functions FP_{B}) is determined by averaging the biotic functions performed by the PI(s) within the map unit. The FP′ is determined by averaging the FP_{A} and FP_{B}. The FP′ is multiplied by area and habitat type (potentially weighted in response to priority) to obtain the measure of functional performance (MFP) for the particular map unit. The summation of the MFPs of the individual map units is the MFP for the site.

Generally, areas with the highest scoring MFP have the highest value in a particular context. Areas with the lowest have the greatest potential for restoration, thereby resulting in an increased overall MFP for the site. The resulting value may be converted to fungible credits and used in ecosystem marketplaces, exchanges, registries; as a basis for business/site owner action; and as a basis for policy or regulatory action.

According to another aspect of the invention, the accounting tool can be used to measure the difference between a site's initial, or baseline, MFP, which uses the same determination methodology as discussed for the MFP value above, and post-design, or future, MFP to determine the site's measure of functional change (MFC) as a debit or credit. The future MFP is determined similar to the baseline MFP, as described above, but with physical and biological indicators and functions as anticipated to exist at some predetermined future (e.g., 5, 10, 15, 20 years) after a particular project is developed. If the number is a credit, it can be sold as a MFC unit in the voluntary market (or progressive regulatory market), or broken down into more traditional credit types more readily recognized by a given regulatory agency. Thus, a given credit can be sold as a MFC or, it can be correlated into the embedded units of measure familiar to the relevant regulatory agency, such as acres of wetland or kilocalories of temperature.

Since MFP is the measurement metric of the present invention and the MFC metric value based on the difference between a MFP in the present (or baseline or initial) ecological condition of a site and a MFP for a future ecological condition for the same site but after development, the MFC value is still the same metric, whether in the form of a debit or credit, and can easily traded in a voluntary market as there is a single metric for both debits and credits.

According to another aspect of the invention, the accounting method for measuring ecological condition or change of a particular site described above (as well as the other methods disclosed herein) is implemented as a software program executed on a computer. In one implementation, for example, all information collected from a field survey, including the quantitative and/or qualitative condition of the PI's present within each map unit, the demarcated within substantially homogeneous map units based on habitat type for each portion of the site, is inputted or retrieved from a previously saved data file. Based on the collected data, the program ultimately calculates the measure of functional change for the entire site and each map unit, using the equations defined below.

These and other advantages will become more apparent upon review of the Drawings, the Detailed Description of the Invention, and the Claims.

### BRIEF DESCRIPTION OF THE DRAWINGS

Like reference numerals are used to designate like parts throughout the several views of the drawings, wherein:

FIG. 1 is a flowchart illustrating a first embodiment for determining ecological condition of a particular site through a measurement of functional performance value (MFP);

FIG. 2 is a flowchart of an alternate embodiment for determining MFP;

FIG. 3 is a representative drawing of a site map identified by individual map units defined by substantially homogeneous habitat types;

FIG. 4 is a chart illustrating the relationship between habitat function and physical and biological indicators of a particular map unit;

FIG. 5 is a photo of a particular site of which map units have been demarcated within substantially homogeneous map units based on habitat;

FIG. 6 is an exemplar excerpted data sheet for field data collection for identifying various habitat types within the map unit with the illustration being for non-aquatic habitat types for Map Unit B-017;

FIG. 7 is an exemplar excerpted data sheet for data collection for identifying functional performance through various indicators within reasonable ranges related to specific ecosystems with the illustration being for vegetation characteristics for Map Unit BA1-10;

FIG. 8 is an exemplar excerpted data sheet for data collection for identifying functional performance through various indicators within reasonable ranges related to specific ecosystems with the illustration being for water regime characteristics for Map Unit B-017;

FIG. 9 is a photo of a particular site of which map unit B-017 is shown for the purpose of the determining the example MFP for that map unit FIG. 10 is a photo like that of FIG. 9 further showing the functional performance indicator results for map unit B-017;

FIG. 11 is a flowchart illustrating a second embodiment for determining beneficial or detrimental change measurement between an initial or baseline performance measurement of a particular site and a performance measurement of the same site at some determined future time;

FIG. 12 is an aerial photo illustrating a site with map units defined for baseline conditions;

FIG. 13 is an aerial photo like that of FIG. 12, except illustrating proposed land modifications as map units B-017 and B-024;

FIG. 14 is a photo like that of FIG. 12 except with a chart highlighting the FP(s) at map unit B-017 of the second embodiment in both the initial and future conditions;

FIG. 15 is a photo and chart like that of FIG. 14, except the chart is for initial and future FP values for map unit B-024;

FIG. 16 is illustrative of a report of various MFC credits calculated for fictional map units B-017 and B-024; and

FIG. 17 is a detailed flowchart for describing a method for determining the MFC credit or debit and how such MFC or change value can be interfaced with a commercial commodities exchange, an exchange registry database, third party accounting tools, or by regulatory agencies.

### DETAILED DESCRIPTION OF THE INVENTION

The simplified, yet more ecologically accurate accounting method of the present invention measures functional performance at a particular site and, according to another embodiment, can also measure changes anticipated to result from future restoration work or other activities performed on, or adjacent to, the site. Because both the measure of functional performance at a site and the measurement of the difference between functional performance at a particular site and the anticipated future condition (positive or negative change) take into account physical and biological properties on a particular site, each measurement is able to give a more accurate ecological condition measurement and, where applicable, detect change at a level of detail much more sensitive than mere “presence or absence” or “high, medium, or low” of a habitat type, function, or theoretical species presence approaches in use today for assessing habitat value.

The described accounting method can be implemented in a wide variety of environments. For example, the measure of functional performance at a site and the measurement of the difference between functional performance at a particular site and the anticipated future condition (positive or negative change) can be implemented at least in part as software comprising computer-executable instructions stored on one or more computer-readable media (for example, one or more CDs, volatile memory components (such as DRAM or SRAM), or nonvolatile memory components (such as hard drives)). Such software may comprise, for example, a software tool used to assess the functional performance of habitats. This particular software implementation should not be construed as limiting in any way, however, as the principles disclosed herein are generally applicable to other software tools.

Any such software can be executed on a desktop computer or on a networked computer (for example, via the Internet, a wide-area network, a local-area network, a client-server network, or other such network). For simplicity, only certain selected aspects of the software-based implementations are described, such as basic keyboard, mouse, and data entry skills. In addition, other details that are well known in the art have also been omitted. For example, it should be understood that the disclosed technology is not limited to any specific computer language, program, or computer. For the same reason, computer hardware for executing the software implementations is not described in further detail. Any of the disclosed methods can alternatively be implemented (partially or completely) in hardware (for example, an ASIC, PLD, or SoC).

The results for the measure of functional performance at a site and the measurement of the difference between functional performance at a particular site and the anticipated future condition (positive or negative change) take into account physical and biological properties on a particular site that result from any of the disclosed methods can be created, updated, or stored on one or more computer-readable media, volatile memory components, or nonvolatile memory components using a variety of different data structures or formats. For example, a data structure comprising the measure of functional performance (for both current and future conditions), the measure of functional change, debits, and/or credits determined by the application of any of the disclosed embodiments may be stored on computer readable-media. Such diagnostic results can be created or updated at a local computer or over a network (for example, by a server computer), using standard data entry methods.

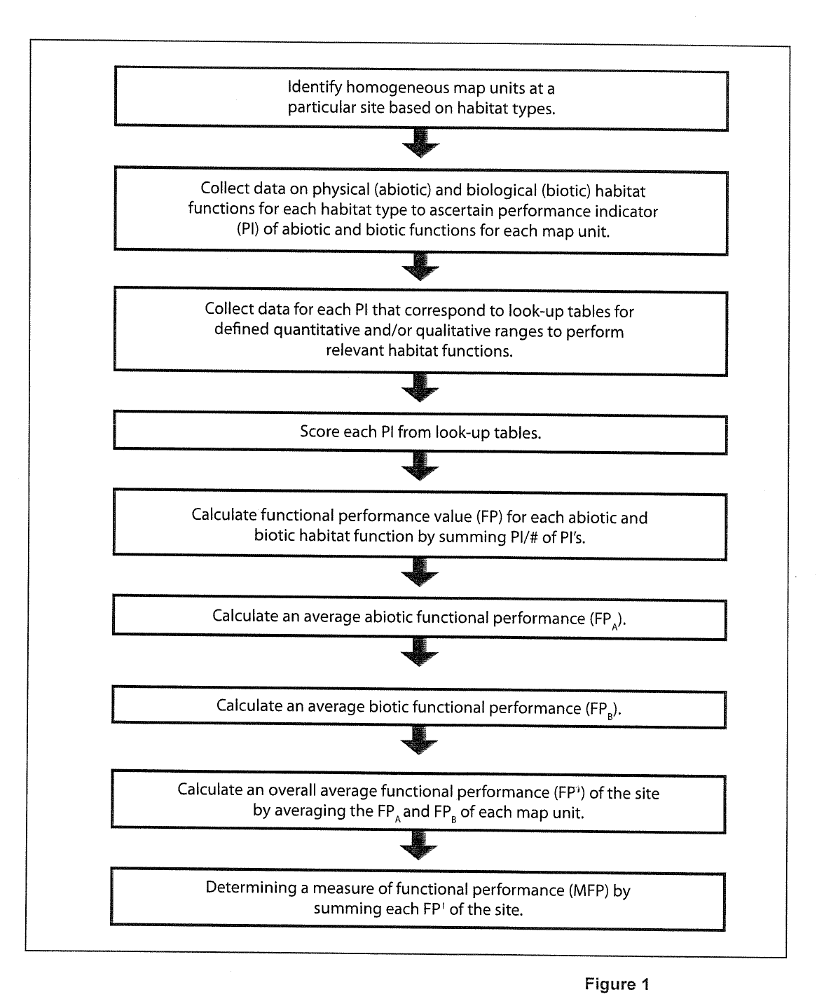

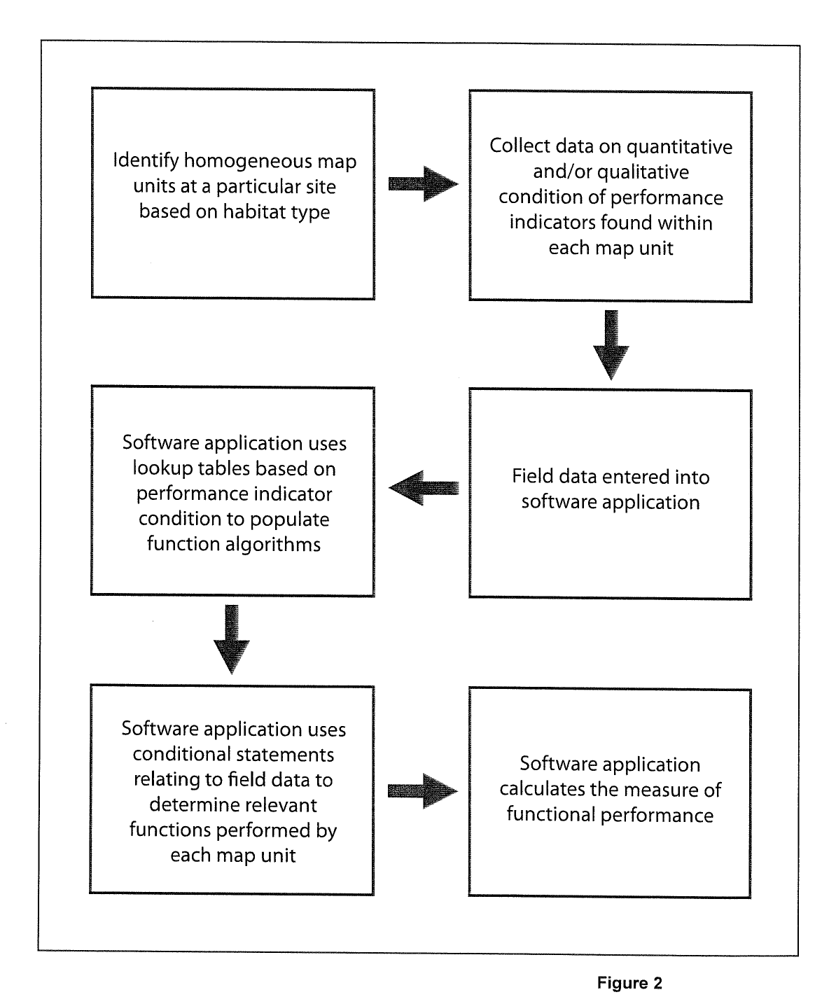

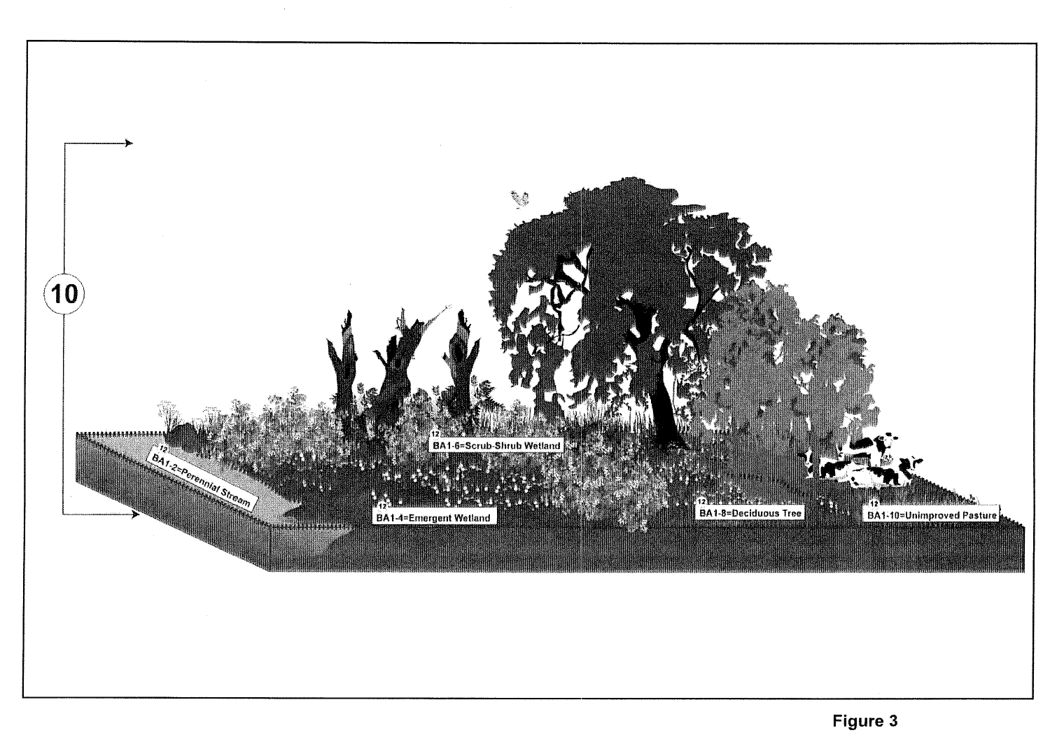

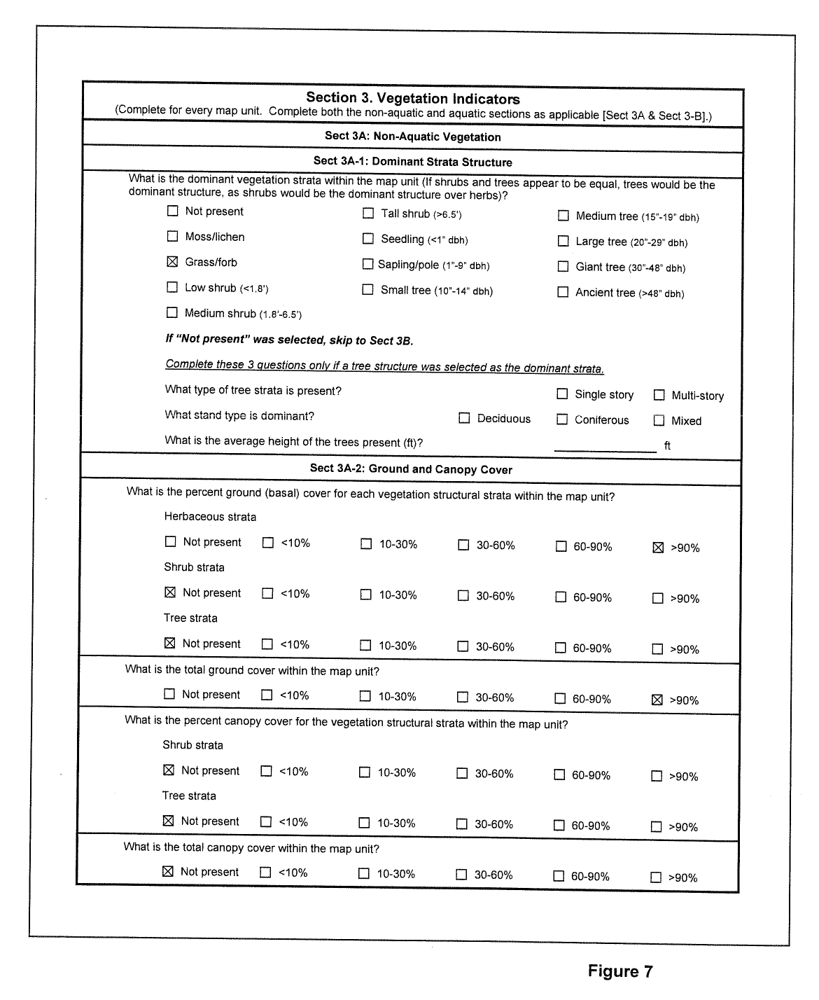

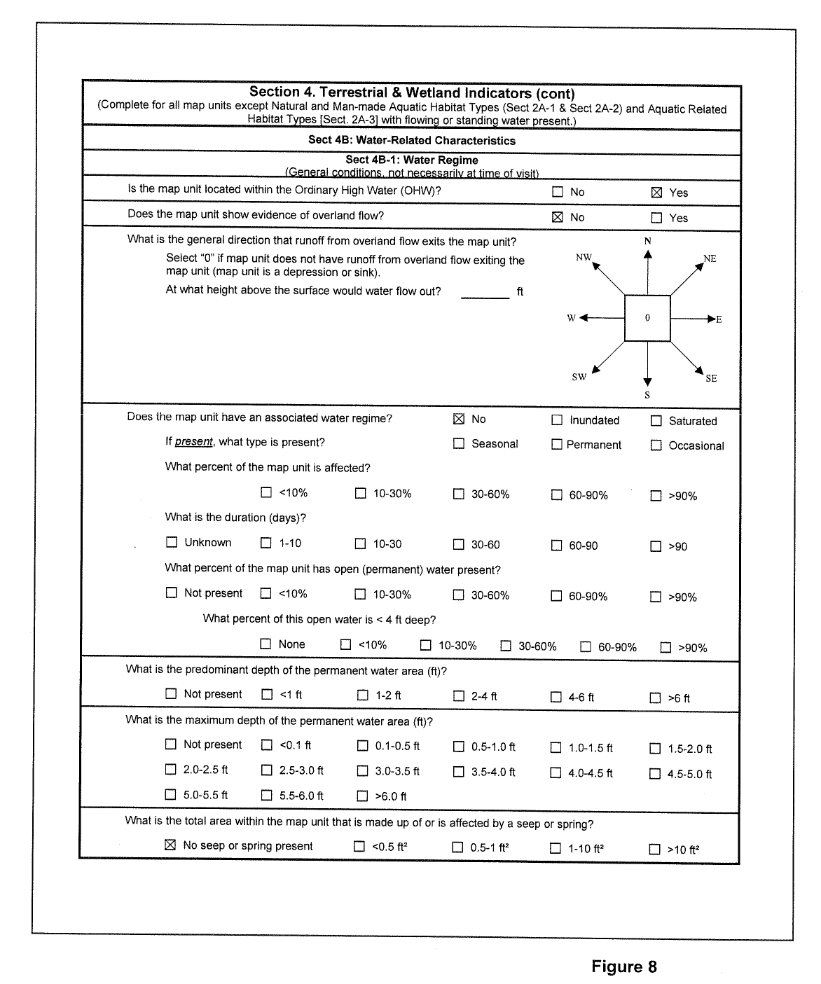

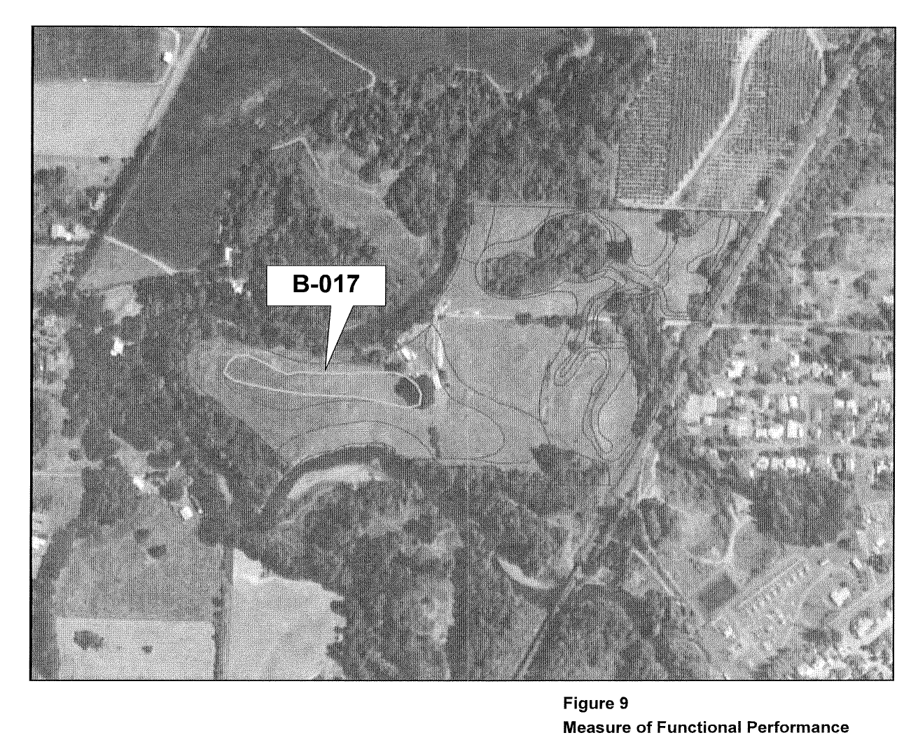

Referring to FIGS. 1, 3-10, a first embodiment of the present accounting method measures functional performance (MFP), or the ecological condition value, at a particular site 10. Because it is rare that a particular site is solely one homogenous habitat type, the site 10 (see FIG. 3) typically is made up of two or more substantially homogeneous habitat types that comprise their own “map units” 12 (also marked as sites BA1-2, BA1-4, BA1-6, BA1-8, and BA1-10 in the example of FIG. 3), based on particular site conditions (e.g., habitat types such as wetlands, grasslands, streams, forests, farmlands, development and/or areas differentiated from one another by key indicators such as the slope of a map unit). In the example represented in FIG. 3, the five map units are identified by various habitat types where Map Unit BA 1-8 is a riparian habitat with trees, Map Unit BA 1-4 is an emergent wetland. Map Unit BA1-2 is a perennial stream, Map Unit BA1-6 is a shrub-scrub wetland, and Map Unit BA1-10 is an unimproved pasture.

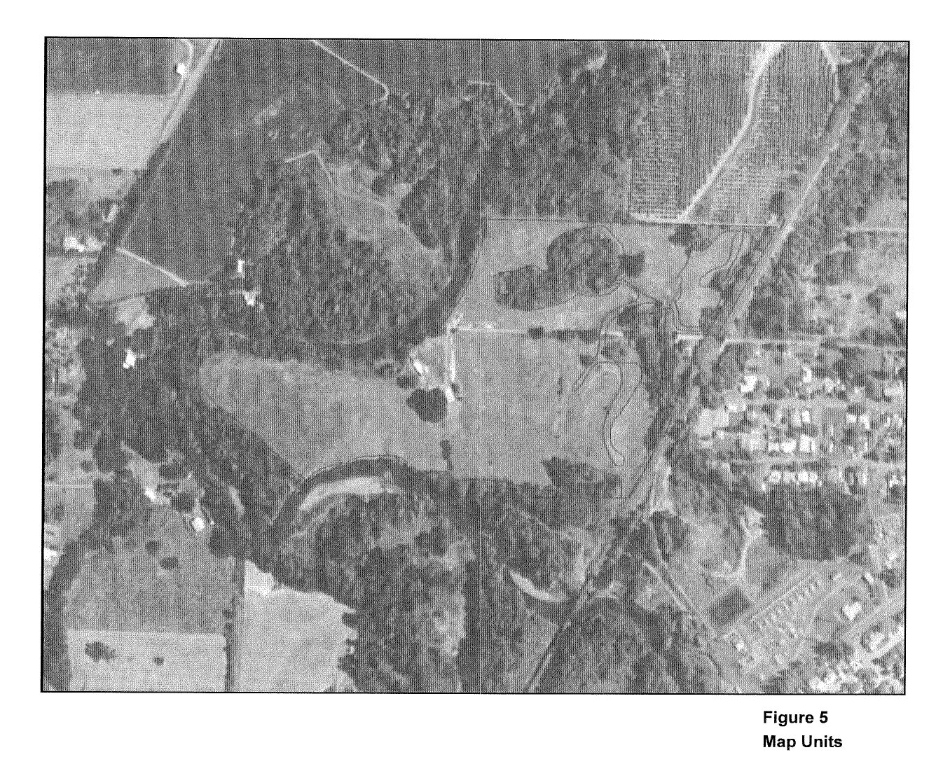

To identify map units at a particular site, a representation or model of the site would be procured. This may be accomplished by securing a map of a particular site. According to one aspect of the invention, such a map may be a high-quality, ortho-rectified air photo (such as the one shown in FIG. 5). According to another aspect of the invention, the map units are digitized using the photo as a reference for the benefit of field work using a geographic information system (GIS) to facilitate and obtain computerized/digitized field data collection.

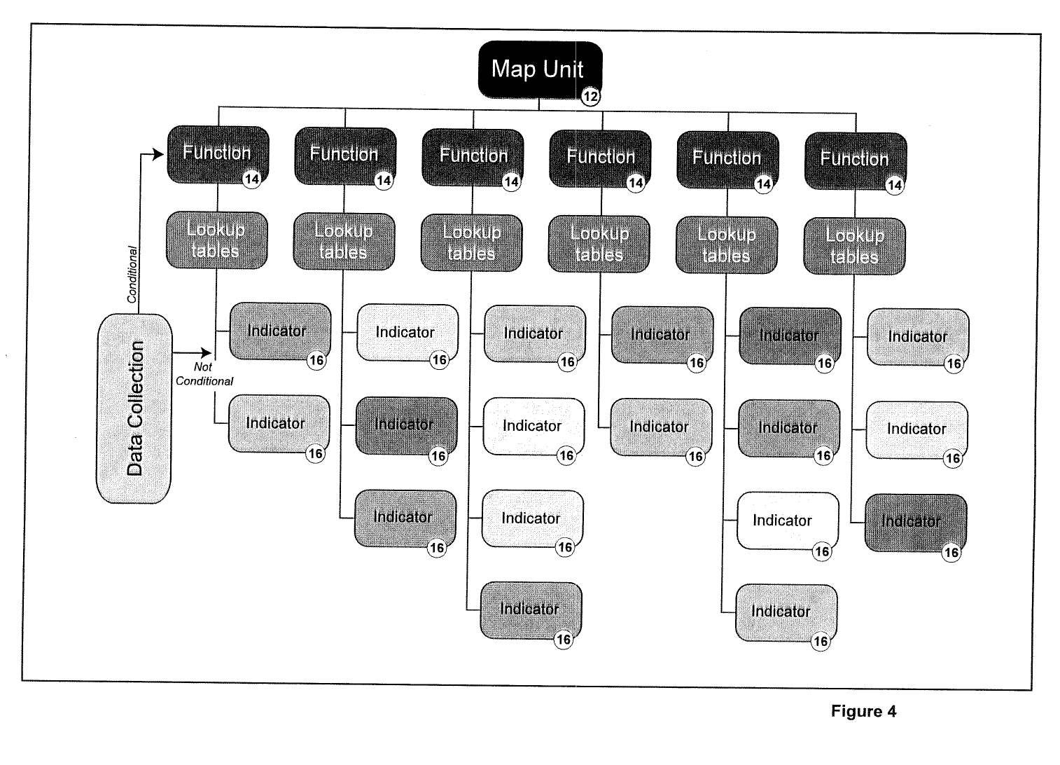

As schematically illustrated in FIG. 4, the data collected for the map unit is used to determine the relevant habitat functions 14 for each map unit. For example, the relevant functions of Map Unit BA 1-8 of FIG. 3 may include aquatic thermoregulation and habitat formation and the relevant functions of Map Unit BA 1-4 may include organic matter export, phosphorus retention, and resident fish habitat support. Logical and conditional statements are embedded within the FP algorithm for each function. The logical and conditional requirements for a given function within a particular ecosystem are commonly known to biologists and are also listed in various text books or guides.

Next, when the data collected for a map unit satisfies these triggering conditions, a score is generated for the function according to the FP algorithm for the function. The algorithm produces a score using the physical and biological indicators 16, such as canopy cover, dominant vegetation, and aquatic substrate composition, which have been identified as relevant to performing a given habitat function for a Map Unit. For example, physical and biological indicators for the functions listed in Map Unit BA1-8 might include overhanging vegetation (for aquatic thermoregulation), down wood (for stream habitat formation). For Map Unit BA1-4, the physical and biological indicators might include area seasonally inundated and distance to nearest water body (for organic matter export), percent total ground cover and slope (phosphorus retention), and presence of permanent water and in-water wood (for resident fish habitat support). The specific physical indicators per habitat function would again be commonly known to biologists and are also listed in various text books or guides.

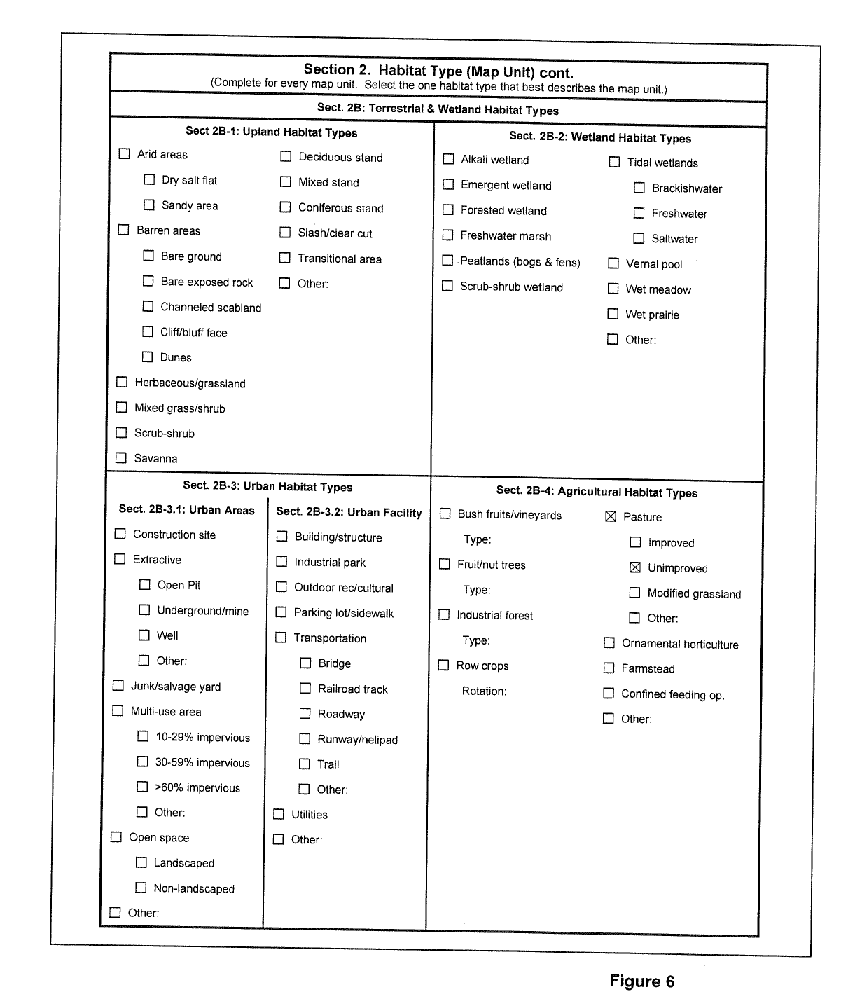

The initial step in calculating the MFP for a site is to divide the site into substantially homogenous map units based on habitat types. This can be completed using a GIS coupled with ortho-rectified aerial imagery, or other software application. The map units identified through this process are then field-truthed and adjusted for boundary accuracy. A field survey is conducted to collect data about the habitat types, physical and biological properties or other characteristics of the particular site for each map unit. Typically, this would be done in conjunction with a qualified biologist using data sheets, such as the illustrated data sheets excerpted in FIGS. 6-8, and found in the types illustrated in the copyrighted field data sheets sets of Appendices A, C, D, and E. The field data can be manually collected or inputted into a computerized format such as on a lap top computer or hand held electronic device. Once the field data has been collected, dependent on the method of collection, it can be electronically transferred (uploaded) or entered into a laptop, desktop, or networked computer that contains the software application that completes the calculations.

Because the accounting system of the present invention is designed to strike a balance between being excessively robust and simple enough to use, the conditional requirements for a function to be evaluated for a map unit, along with the FP equations, the PI's relevant to each FP equation, and lookup tables relating the PI's condition to scores used in the FP equations have all been implemented as part of a computer software application. The functions scored by the present invention, use 2-7 indicators for scoring. In general, while using this number of indicators per function is a good range, the present invention is not limited to a specific range given that some functions may necessarily have less or require more indicators to accurately gauge physical properties at a particular site for a particular function. Thus, one of skill would know that a reasonable range of indicators will be based on a particular habitat and its relevant functions. The values for indicators used in the lookup tables may be based on published data that provide categorical evaluations of parameters that describe a given index value. The range of Functional Performance (FP) values (e.g., 0%-100%) is relative to the values provided in literature that describe an accepted range of conditions for a particular function or indicator. The specific equations and lookup tables found within the application can be found in copyrighted database Appendix B.

The field data sheets, whether in print form or some electronic or Web-accessed format, contain all the PI's and other relevant information needed by the present invention to calculate the measure of functional change. The range of data collected for each PI on the datasheet matches the ranges used in the lookup tables. Referring to FIGS. 5-8 and Appendix B, to obtain a “score” or value for each PI, for each relevant function, the present invention matches the condition of the PI recorded on the datasheet to the PI's corresponding value in the lookup table for the function. This value is then used in the FP equation for that function. The method for determining the combined value of multiple indicators for a function is described below.

While look-up tables were created for the functions and indicators used within the present invention, assigning look-up values to the indicators is within the skill range of a proficient field biologist. These numbers are based on field assessments for parameters that proficient field biologists would know. While full examples are shown in the look-up tables shown in Appendix B, and also from the field data sheets of Appendices A, C, and D in connection with herbaceous ground cover, shrub ground cover, tree ground cover, total canopy cover, number of plant species, snags (note look-up tables can differ between habitat types), number of vegetation strata, distance to water, soil disturbance, total ground cover, etc., one of skill would know that certain geographic areas would need to adjust valuations from the look-up tables to account for specific site habitats (e.g., indicators and functions associated with emergent wetlands are more rare in eastern Oregon (arid environment) than in the Willamette Valley in western Oregon because of different hydrologic and climatic conditions). Values may be adjusted or weighted in order to account for their increased significance and rarity in different geographies and functions. For other functions not defined in the look-up tables here, one of skill would know to ascertain PI values from key reference sources such as information related to soil quality from the U.S. Department of Agriculture at: http://soils.usda.gov/sqi/assessment/files/sq_assessment_cp.pdf, or soil carbon at http://cometvr.colostate.edu/tool/default.asp?action=1; stream indicators from the Environmental Protection Agency
at: http://www.epa.gov/owow/monitoring/wsa/09_rapid habitat.pdf, groundwater recharge at the local county records such as found at:
   http://www.metroke.gov/ddes/cao/PDFs04ExecProp/BAS-Chap6-04.pdf, canopy cover and shade: http://www.krisweb.com/biblio/gen_oregon_xxxx_{—}1999 wqmanualchap14.pdf, wetlands: http://www.ecy.wa.gov/pubs/0506006.pdf, wetland buffers: http://www.cookescientific.com/SAM%20Stuff/SAM2000.pdf, phosphorous levels: http://www.nrcs.usda.gov/TECHNICAL/ECS/nutrient/pindex.html; nitrogen levels: http://www.epa.gov/ada/download/reports/600R05118/600R05118.pdf, and tidal and wetland areas: http://www.oregon.gov/DSL/WETLAND/docs/tidal_HGM_pt1.pdf. This information and disclosures are non-limitive. But they are disclosed here as a means to show that skilled field biologists would have a myriad of resources to assign values to certain indicators within a range (e.g., <10%, 10-30%, 30-60%, 60-90%, and >90%, or measurement ranges in terms of length or area, number of downed wood pieces 1-3, 4-7, 8-12, 13-20, >20, etc.).

Further, field biologists can access PI values through various governmental regulatory agencies. For example, the EPA is launching indicator values meant to distinguish between ephemeral, perennial and intermittent streams.

Once the PI value is determined, the calculation of the Function Performance (FPₘᵤ) value, for any given function for the map unit, is determined by the summation of each indicator's PI divided by the number of indicators (n) in the map unit. A PI can be and individual physical or biological indicator, or it can be comprised of multiple physical and/or biological indicators. In general the equation format for scoring the FPₘᵤ is expressed as:

$${FP}_{mu} = \frac{\sum {PI}_{mu}}{n}$$

where
FPₘᵤ=Function Performance (Map Unit),
PIₘᵤ=Performance Indicator (Map Unit), and
n=Number of Indicators (Map Unit).

Once the FPₘᵤ value is calculated for each relevant function, a total functional performance (FP′ₘᵤ) for the map unit can be derived equally from the contributions of the abiotic and biotic functions (Appendix B). Each function within the accounting systems is identified as either an abiotic or biotic function. The functional performance for abiotic functions (FP,) is determined by averaging the abiotic functions performed by the PI(s) within the map unit. The functional performance for the biotic functions FP_{Bmu}) is determined by averaging the biotic functions performed by the PI(s) within the map unit. The FP′ₘᵤ is determined by averaging the FP_{Amu} and FP_{Bmu}. In general equation format, the FP_{Amu}, FP_{Bmu}, FP′ₘᵤ are expressed as:

$$F {P}_{Amu} = \frac{\sum {PI}_{muai}}{{n}_{muai}}$$

$$F {P}_{Bmu} = \frac{\sum {PI}_{mubi}}{{n}_{mubi}}$$

$$F {P}_{mu}^{′} = \frac{F {P}_{Amu} + F {P}_{Bmu}}{2}$$

where
FP_{Amu}=Abiotic Functional Performance (Map Unit),
FPₘᵤₐᵢ=Relevant Abiotic Functional Performance Scores (Map Unit),
nₘᵤₐᵢ=Number of Relevant Abiotic Functions Performed (Map Unit),
FP_{Bmu}=Biotic Functional Performance (Map Unit),
FP_{mubi}=Relevant Biotic Functional Performance Scores (Map Unit),
N_{mubi}=Number of Relevant Biotic Functions Performed (Map Unit), and
FP′ₘᵤ=Overall Functional Performance (Map Unit),

The embodiments of the present invention use the following specific equations along with the look-up tables in Appendix B (scores taken from the look-up tables are determined from the data collected on the field datasheet, representations can be found in Appendixes A, C, and D) to determine the FP for each of the abiotic and biotic functions, such as channel diversity for flowing water habitat types; filtration; groundwater recharge; habitat formation; infiltration; natural plant selection; nitrogen removal, organic matter production, phosphorous retention and others.

Channel Diversity (CD)

### Function Applies to Flowing Water Habitat Types

### Modifiers

Function habitat type modifiers (Hmod)
   Intermittent & ephemeral=0.5
   All other habitat types=1
Channel incision modifier (CImod)

$$If \frac{CI}{OHWh} \geq 1.5 CI mod = 0.5$$

Otherwise=1

### Calculated Indicators

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)
Floodplain access (FpA)
   If floodplain access=“constrained”, then FpA=0
      else

$$F p A = ( \frac{OHWw}{WW} )$$

### Flowing Water Aquatic Habitat Types Only

$$( \frac{( Pa + AqGR + AqSub + ( F p A ⋆ CI mod ) )}{4} ) ⋆ Hmod$$

where
AqGR=Gradient (slope) of the water surface,
AqSub=Aquatic substrate composition,
Bdrk=Bedrock component of aquatic substrate,
Bldr=Boulder component of aquatic substrate,
Cb=Cobble component of aquatic substrate,
CD=Channel diversity function score,
CI=Channel incision depth,
CImod=Channel incision modifier,
FpA=Floodplain access,
G/C=Gravel/cobble component of aquatic substrate,
Hmod=Habitat type modifier,
MMi=Man-made impervious component of aquatic substrate,
MMp=Man-made pervious component of aquatic substrate,
OHWh=Ordinary high water height,
OHWw=Ordinary high water width,
Org=Organic component of aquatic substrate,
Pa=Pool area,
Rk=Rock component of aquatic substrate,
S/C=Silt/clay component of aquatic substrate,
Snd=Sand component of aquatic substrate,
U=Unknown component of aquatic substrate, and
WW=Wetted width.

Filtration (FiL)

### Function Applies to All Habitat Types

For all except flowing and still water habitat types, slope must be ≦10% in order for the function to be performed
   Slp≦10%

### Modifiers

Function habitat type modifiers (Hmod)
   Intermittent & ephemeral=0.5
   All other habitat types=1

### Flowing & Still Water Aquatic Habitat Types

$$( \frac{( SH 20 + ( Em\_veg + Sub\_veg ) )}{2} ) ⋆ Hmod$$

### Wetland Habitat Types

$$( \frac{\begin{matrix}SH 20 + ( Em\_veg + Sub\_veg ) + \\ ( \frac{G C h + G C s + G C t}{3} ) + Micro + L \text{/} D\end{matrix}}{5} ) ⋆ Hmod$$

### All Remaining Habitat Types

$$( \frac{( \frac{G C h + G C s + G C t}{3} ) + Micro + L \text{/} D}{3} ) ⋆ Hmod$$

where
Em_veg=Emergent vegetation cover,
FiL=Filtration function score,
GCh=Ground cover herbaceous strata,
GCs=Ground cover shrub strata,
GCt=Ground cover tree strata,
Hmod=Habitat type modifier,
L/D=Litter/duff,
Micro=Microtopography,
SH2O=Open water<4′ deep,
Slp=Slope of the land surface, and
Sub_veg=Submergent vegetation cover.

Groundwater Recharge (GWR)

### Function Applies to All Habitat Types Except Still Water

Terrestrial, aquatic related, urban, and agricultural habitat types must be within OHW (ordinary high water) of a flowing water aquatic habitat type in order to be scored for the groundwater recharge function

### Modifiers

Function habitat type modifiers (Hmod)
   Intermittent & ephemeral=0.5
   All other habitat types=1

### Calculated Indicators

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)
Floodplain access (FpA)
   If floodplain access=“constrained”, then FpA=0 else

$$F p A = ( \frac{OHWw}{WW} )$$

### Flowing Water Aquatic Habitat Types

$$( \frac{( F p A + AqSub )}{2} ) ⋆ Hmod$$

### Wetland and all Remaining Qualifying Habitat Types

(Hydro_grp)*H mod

where
AqSub=Aquatic substrate composition,
Bdrk=Bedrock component of aquatic substrate,
Bldr=Boulder component of aquatic substrate,
Cb=Cobble component of aquatic substrate,
FpA=Floodplain access,
G/C=Gravel/cobble component of aquatic substrate,
GWR=Ground water recharge function score,
Hmod=Habitat type modifier,
Hydro_grp=NRCS hydrologic group,
MMi=Man-made impervious component of aquatic substrate,
MMp=Man-made pervious component of aquatic substrate,
OHWh=Ordinary high water height,
OHWw=Ordinary high water width,
Org=Organic component of aquatic substrate,
Rk=Rock component of aquatic substrate,
S/C=Silt/clay component of aquatic substrate,
Snd=Sand component of aquatic substrate,
U=Unknown component of aquatic substrate, and
WW=Wetted width.

Habitat Formation (HF)

### Function Applies to All Habitat Types Except Natural Still Water

Indicators currently not identified for natural still water habitats

### Modifiers

Habitat type modifier (Hmod)
   Intermittent & ephemeral=0.5
   All other habitat types=1
Valley form modifier (VF)
   Unconstrained=1
   Constrained=0.75
Non-native vegetation modifier (NNveg)
Geomean of non-native emergent cover, non-native submergent cover, and non-native floating mat cover using the following values for each stratum
   Layer not present=1
   All native=1
   <10%=1
   10-30%=0.9
   30-60%=0.8
   60-90%=0.7
   >90%=0.6
Total canopy cover (CCtot) modifier for large wood recruitment (LWr)
   Open canopy (10-30%)=0.75
   Moderate canopy (30-60%)=0.9
   Closed canopy (>60%)=1.0

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{MUa}$$

Aquatic substrate composition without boulder component (AqSubc)
   The aquatic substrate performance indicator is calculated by summing the scores for the individual substrate categories present within the map unit. The maximum score for this indicator is 100%.
      Aquatic substrate equation does not include boulders (Bldr) as it is scored separately.

AqSubc=(Org+S/C+Snd+G/C+Cb+Rk+Bdrk+MMp+MMi+U)
Soil substrate composition (SSub)
   The soil substrate performance indicator is calculated by summing the scores for the individual substrate categories present within the map unit. The maximum score for this indicator is 100%.

SSub=(SOrg+SS/C+SSnd+SG/C+SCb+SRk+SBldr+SBdrk+SMMp+SMMI+SU)

### Flowing Water Aquatic Habitat Types

$$( ( \frac{( Bldr + L W V + AqSubc + Pa )}{4} ) ⋆ VF ) ⋆ Hmod$$

### Wetland and Still Water Man-Made Aquatic Habitat Types

$$( ( \frac{( \begin{matrix}\begin{matrix}SH 20 + Iseasarea + \\ Iseasdur +\end{matrix} \\ ( TAqVeg ⋆ NNveg )\end{matrix} )}{4} ) + ( \frac{( \begin{matrix}\begin{matrix}\begin{matrix}( nDW + nDWc ) + \\ ( DomTerr ⋆ C C t t ) +\end{matrix} \\ SSub + L \text{/} D +\end{matrix} \\ ( C C t + C C s )\end{matrix} )}{9} ) ) ⋆ Hmod$$

### All Remaining Habitat Types (Except Natural Still Water)

$$( \frac{( \begin{matrix}( nDW + nDWc ) + ( DomTerr ⋆ C C t ) + \\ SSub + L \text{/} D + ( C C t + C C s )\end{matrix} )}{5} ) ⋆ Hmod$$

where
AqSubc=Aquatic substrate composition without boulders component,
Bdrk=Bedrock component of aquatic substrate,
Bldr=Boulder component of aquatic substrate,
Cb=Cobble component of aquatic substrate,
CCs=Canopy cover of shrub strata,
CCt=Canopy cover of tree strata,
CCtot=Total canopy cover,
DomTerr=Dominant terrestrial structure (Large wood recruitment),
G/C=Gravel/cobble component of aquatic substrate,
HF=Habitat formation function score,
Hmod=Habitat type modifier,
Iseasarea=Percent area of seasonal inundation,
Iseasdur=Duration of seasonal inundation,
L/D=Litter/duff,
LWV=Large wood volume,
MMi=Man-made impervious component of aquatic substrate,
MMp=Man-made pervious component of aquatic substrate,
MUa=Map unit area (ft),
nAW=Number of adjacent habitat types (wetland and/or aquatic, value=1 or 2),
nDW=Number of down wood pieces present,
nDWc=Number of decay classes present in the down wood,
nLWD=Number of large wood pieces by diameter and length class,
NNveg=Non-native vegetation modifier,
nRW=Number of large wood pieces with an attached rootwad by diameter and size class,
Org=Organic component of aquatic substrate,
Pa=Pool area,
Rk=Rock component of aquatic substrate,
RW=Rootwad,
S/C=Silt/clay component of aquatic substrate,
SBdrk=Bedrock component of soil substrate,
SBldr=Boulder component of soil substrate,
SCb=Cobble component of soil substrate,
SG/C=Gravel/cobble component of soil substrate,
SH2O=Open water<4′ deep,
SMMi=Man-made impervious component of soil substrate,
SMMp=Man-made pervious component of soil substrate,
Snd=Sand component of aquatic substrate,
SOrg=Organic component of soil substrate,
SRk=Rock component of soil substrate,
SS/C=Silt/clay component of soil substrate,
SSnd=Sand component of soil substrate,
SSub=Soil substrate composition,
SU=Unknown component of soil substrate,
TAqVeg=Total aquatic vegetation cover,
U=Unknown component of aquatic substrate,
VF=Valley from modifier,
Vlu=Large wood volume from lookup table, and
Vtot=Total volume of large wood.

Infiltration (InF)

### Function Applies to All Habitat Types Except Flowing and Still Water

Slope must be ≦10% in order for the function to be performed
   Slp≦10%
Permeability indicator is scored as 0 if >30% of the soil surface is visually disturbed
   SoilDist<30%

### Modifiers

Habitat type modifier (Hmod)
   All habitat types=1

### All Map Units Except Flowing and Still Water

$$( \frac{G C t ot + ( C C s + C C t ) + Hydro\_grp + micro}{4} ) ⋆ Hmod$$

where
CCs=Canopy cover of shrub strata,
CCt=Canopy cover of tree strata,
GCtot=Total ground cover,
Hmod=Habitat type modifier,
Hydro_grp=NRCS hydrologic group,
InF=Infiltration function score,
Micro=Microtopography,
Slp=Slope of the land surface, and
SoilDist=Soil disturbance.

Natural Plant Succession (NP)

### Function Applies to all Habitat Types Except Flowing and Still Water Habitats

### Modifiers

Habitat type modifier (Hmod)
   All habitat types=1
Non-native species modifier (NNspp)
   If any of the following non-native species are present, English ivy, Himalayan blackberry, or Japanese knotwood, the combined non-native ground/canopy cover score is reduced by 50%
      NNspp=0.5
         English ivy, Himalayan blackberry, or Japanese knotwood present
      NNspp=1
Vegetation structure strata type modifier (VSstory)
   VSstory=1.1 if tree structure=multi-story
   VSstory=1 if tree structure=single story
Vegetation structure habitat type modifier (VShab)
   VShab=0.5 if habitat type=Industrial forest
   VShab=1 for all other habitat types

### Calculated Indicators

Dominant terrestrial structure (DomTerr)
   The dominant terrestrial structure score is taken from the lookup tables unless the map unit is a;
      Peatland
      Tidal brackishwater wetland,
      Tidal freshwater wetland,
      Tidal saltwater wetland,
      Vernal pool,
      We meadow, or
      Wet prairie
   For the listed habitat types the dominant terrestrial structure score is 10

### All Habitat Types Except Flowing and Still Water

$$( \frac{\begin{matrix}( ( \frac{( N N C h + N N C s + N N C t )}{3} ) ⋆ NNspp ) + \\ ( ( DomTerr ⋆ VSstory ) ⋆ VShab ) + SoilDist\end{matrix}}{3} ) * Hmod$$

where
NNspp=Non-native species ground/canopy cover modifier,
VSstory=Vegetation structure strata type modifier,
VShab=Vegetation structure habitat type modifier,
NNCh=Non-native cover herbaceous strata,
NNCs=Non-native cover shrub strata,
NNCt=Non-native cover tree strata,
DomTerr=Dominant terrestrial structure,
SoilDist=Soil disturbance,
NP=Natural plant succession function, and
Hmod=Habitat type modifier.

### Nitrogen Removal (NOx)

### Function Applies to all Habitat Types Except Flowing and Still Water Habitats

Map unit must have total ground cover >90% in order for function to apply

### Modifiers

Habitat type modifier (Hmod)
   All habitat types=1
Number and type of vegetation strata present (VegStrata)
   If herbaceous, shrub, and tree strata present VegStrata=1
   If herbaceous and tree strata present VegStrata=0.95
   If herbaceous and shrub strata present VegStrata=0.85
   If only one strata present VegStrata=0.8
Slope (Slpmod)
   If slope is <5% Slpmode=1
   If slope is 5-10% Slpmode=0.95
   If slope is 10-15% Slpmode=0.8
   If slope is 15-20% Slpmode=0.6
   If slope is >20% Slpmode=0

### All Habitat Types Except Flowing and Still Water

$$( ( \frac{( BuffWidth ⋆ Slpmod ) + WatReg}{2} ) ⋆ VegStrata ) ⋆ H mod$$

where
VegStrata=Number and type of vegetation strata present,
Slpmod=Slope modifier,
BuffWidth=Buffer width, width of map unit perpendicular to flow,
WatReg=Associated water regime,
NOx=Nitrogen removal function, and
Hmod=Habitat type modifier.

Organic Matter Production (OMP)

### Function Applies to All Habitat Types Except Still Water

### Modifiers

Function habitat type modifiers (Hmod)
   Intermittent & ephemeral=0.5
   All other habitat types=1
Vegetation disturbance regime modifier
   Vegetation disturbance regime score is modified by the percent of the map unit that contains the disturbed area (DistArea)
      If <10%, DistArea=1
      If 10-30%, DistArea=0.9
      If 30-60%, DistArea=0.8
      If 60-90%, DistArea -0.7
      If >90%, DistArea=0.5

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
   Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{M U a}$$

### Flowing Water Aquatic and Natural Aquatic Related Habitat Types

$$( \frac{L W V + TAqVeg}{2} ) ⋆ H mod$$

### Wetland Habitat Types

$$( \frac{\begin{matrix}\begin{matrix}( \frac{G C h + G C s + G C t}{3} ) + TAqVeg + \\ ( \frac{L W V + ( \frac{nDW + nD Wc}{2} ) + ( \frac{nSnags + nSnagsdc}{2} )}{3} ) +\end{matrix} \\ L \text{/} D + PredSoil + SoilDist + ( VegDist ⋆ DistArea )\end{matrix}}{7} ) ⋆ H mod$$

### All Remaining Habitat Types (Except Still Water)

$$( \frac{\begin{matrix}\begin{matrix}( \frac{G C h + G C s + G C t}{3} ) + \\ ( \frac{( \frac{nDW + nDWc}{2} ) + ( \frac{nSnags + nSnagsdc}{2} )}{2} ) +\end{matrix} \\ L \text{/} D + PredSoil + SoilDist + ( VegDist ⋆ DistArea )\end{matrix}}{6} ) ⋆ H mod$$

where
DistArea=Area of vegetation disturbance modifier,
GCh=Ground cover herbaceous strata,
GCs=Ground cover shrub strata,
GCt=Ground cover tree strata,
Hmod=Habitat type modifier,
L/D=Litter/duff,
LWV=Large wood volume,
MUa=Map unit area (ft),
nDW=Number of down wood pieces present,
nDWc=Number of decay classes present in the down wood,
nLWD=Number of large wood pieces by diameter and length class,
nRW=Number of large wood pieces with an attached rootwad by diameter and size class,
nsnags=Number of snags present,
nsnagsdc=Number of decay classes present in the snags,
OMP=Organic matter production function score,
PredSoil=Dominant soil composition,
RW=Rootwad,
TAqVeg=Total aquatic vegetation cover,
VegDist=Vegetation disturbance regime,
Vlu=Large wood volume from lookup table, and
Vtot=Total volume of large wood.

Phosphorus Retention (POx)

### Function Applies to all Habitat Types Except Flowing and Still Water Habitats

### Modifiers

Habitat type modifier (Hmod)
   All habitat types=1
Total ground cover modifier (GCmod)
   If total ground cover=Not present, GCmod=0
   If total ground cover=<10%, GCmod=0
   If total ground cover=10-30%, GCmod=0.1
   If total ground cover=30-60%, GCmod=0.5
   If total ground cover=60-90%, GCmod=0.8
   If total ground cover=>90%, GCmod=1
Slope (Slpmod)
   If slope is <5% Slpmode=1
   If slope is 5-10% Slpmode=0.9
   If slope is 10-15% Slpmode=0.7
   If slope is 15-20% Slpmode=0.5
   If slope is >20% Slpmode=0

### All Habitat Types Except Flowing and Still Water

$$( ( \frac{( BuffWidth ⋆ Slpmod ) + InF + Fil}{3} ) ⋆ G C mod ) ⋆ H mod$$

where
BuffWidth=Buffer width, width of map unit perpendicular to flow,
Fil=Filtration function score,
GCmod=Total ground cover modifier,
Hmod=Habitat type modifier,
InF=Infiltration function score,
POx=Phosphorus retention function, and
Slpmod=Slope modifier.

Pollination (PoL)

### Function Applies to All Habitat Types Except Flowing and Still Water Habitats

### Modifiers

Habitat type modifier (Hmod)
   All habitat types=1
Non-native species modifier (NNspp)
   If any of the following non-native species are present, English ivy, Himalayan blackberry, or Japanese knotwood, the combined non-native ground/canopy cover score is reduced by 50%
      NNspp=0.5
         English ivy, Himalayan blackberry, or Japanese knotwood present
      NNspp=1

### All Habitat Types Except Flowing and Still Water

$$( \frac{\begin{matrix}\begin{matrix}D\_H 2 O + ( ( \frac{( N N C h + N N C s + N N C t )}{3} ) ⋆ NNspp ) + \\ ( \frac{Herb\_Ntv + Shrub\_Ntv + Tree\_Ntv}{3} ) +\end{matrix} \\ SoilDist + G C tot + nSnags + Hydro\_grp\end{matrix}}{7} ) ⋆ H mod$$

where
D_H2O=Distance to water,
GCtot=Total ground cover,
Herb_Ntv=Number of native herbaceous spp,
Hmod=Habitat type modifier,
Hydro_grp=NRCS hydrologic group,
NNCh=Non-native cover herbaceous strata,
NNCs=Non-native cover shrub strata,
NNCt=Non-native cover tree strata,
NNspp=Non-native species ground/canopy cover modifier,
nSnags=Number of snags present,
PoL=Pollination function score,
Shrub_Ntv=Number of native shrub spp,
SoilDist=Soil disturbance, and
Tree-Ntv=Number of native tree spp.

Soil/Substrate Stability (SSt)

### Function Applies to All Habitat Types Except Flowing and Still Water Aquatic

Habitat types adjacent to aquatic and/or wetland habitat types use the bank stability formula
   Wetland habitat types are always calculated using soil stability formula

### Modifiers

Function habitat type modifiers (Hmod)
   All habitat types=1

### Calculated Indicators

Soil substrate composition (SSub)
   The soil substrate performance indicator is calculated by summing the scores for the individual substrate categories present within the map unit. The maximum score for this indicator is 100%.

Ssub=(SOrg+SS/C+SSnd+SG/C+SCb+SRk+SBldr+SBdrk+SMMp+SMMi+SU)

Soil Stability Formula

$$( \frac{( SoilDist + G C h + ( \frac{C C s + C C t}{2} ) + Slp )}{4} ) ⋆ H mod$$

Bank Stability Formula

$$( \frac{\begin{matrix}( \frac{( G C h + Slp )}{2} ) + ( \frac{( G C s + Slp )}{2} ) + \\ ( \frac{( G C t + Slp )}{2} ) + SSub\end{matrix}}{4} ) ⋆ H mod$$

where
CCs=Canopy cover of shrub strata,
CCt=Canopy cover of tree strata,
GCh=Ground cover herbaceous strata,
GCs=Ground cover shrub strata,
GCt=Ground cover tree strata,
Hmod=Habitat type modifier,
SBdrk=Bedrock component of soil substrate,
SBldr=Boulder component of soil substrate,
SCb=Cobble component of soil substrate,
SG/C=Gravel/cobble component of soil substrate,
Slp=Slope of the land surface,
SMMi=Man-made impervious component of soil substrate,
SMMp=Man-made pervious component of soil substrate,
SoilDist=Soil disturbance,
SOrg=Organic component of soil substrate,
SRk=Rock component of soil substrate,
SS/C=Silt/clay component of soil substrate,
SSnd=Sand component of soil substrate,
SSt=Soil/substrate stability function score,
SSub=Soil substrate composition, and
SU=Unknown component of soil substrate.

Spatial Separation (SS)

Function Applies to All Habitat Types Located within OHW

### Modifiers

Function habitat type modifiers (Hmod)
   Intermittent & ephemeral=0.5
   All other habitat types=1

Flowing Water Aquatic Habitat Types

$$( ( \frac{( DAq + MDpth + Pa + M U type )}{3} ) ) ⋆ H mod$$

Wetland Habitat Types

$$( ( \frac{( MDpth + MUtype )}{2} ) ) ⋆ H mod$$

All Remaining Habitat Types

(MUtype)*H mod

where
DAq=Dominant aquatic structure,
Hmod=Habitat type modifier,
MDpth=Maximum depth,
Pa=Pool area, and
SS=Spatial separation function score.

Streambed Stability (StrSt)

### Function Applies Flowing Water Aquatic Habitat Types Only

Indicators currently not identified for natural still water habitats

### Modifiers

Habitat type modifier (Hmod)
   Intermittent & ephemeral=0.5
   All other habitat types=1

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{M U a}$$

Aquatic substrate composition without boulder component (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)

### Flowing Water Aquatic Habitat Types

$$( \frac{AqSub + ( \frac{AqGR + MDpth + BFh}{3} ) + L W V}{3} ) ⋆ H mod$$

where
AqGR=Gradient (slope) of the water surface,
AqSub=Aquatic substrate composition,
Bdrk=Bedrock component of aquatic substrate,
BFh=Bank-full height,
Bldr=Boulder component of aquatic substrate,
Cb=Cobble component of aquatic substrate,
G/C=Gravel/cobble component of aquatic substrate,
Hmod=Habitat type modifier,
LWV=Large wood volume,
MDpth=Maximum depth,
MMi=Man-made impervious component of aquatic substrate,
MMp=Man-made pervious component of aquatic substrate,
MUa=Map unit area (ft),
nAW=Number of adjacent habitat types (wetland and/or aquatic, value=1 or 2),
nLWD=Number of large wood pieces by diameter and length class,
nRW=Number of large wood pieces with an attached rootwad by diameter and size class
Org=Organic component of aquatic substrate,
Rk=Rock component of aquatic substrate,
RW=Rootwad,
S/C=Silt/clay component of aquatic substrate,
StrSt=Streambed stability function score,
U=Unknown component of aquatic substrate, and
Vlu=Large wood volume from lookup table.

Temperature Regulation (TR)

### Function Applies to All but Still Water Aquatic Habitat Types

Non-aquatic habitat types must be located adjacent to an aquatic and/or wetland habitat type
   Wetland habitat types are always scored

### Modifiers

Function habitat type modifiers (Hmod)
   Intermittent & ephemeral=0.5
   All other habitat types=1
Seeps modifier (Smod)
   Seeps present=1.1
   No seeps present=1
Geographic aspect (GA)
   South=1
   West=0.75
   East=0.75
   North=0.5

### Calculated Indicators

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)

Flowing Water Aquatic Habitat Types

$$( \frac{( OH 2 O + TAqVeg + AgSub )}{3} ) ⋆ H mod$$

Wetland Habitat Types

$$( ( \begin{matrix}( \frac{( \begin{matrix}( C C t + C C s ) + IPDpth + \\ OH 2 O + TAgVeg\end{matrix} )}{4} ) + \\ ( \frac{( S + \frac{( Shda + ( Shdw ⋆ G A ) )}{nAW} )}{6} )\end{matrix} ) ⋆ S mod ) ⋆ H mod$$

Adjacent to Wetland and/or Aquatic Habitat Types

$$( ( S + ( \frac{Shda + ( Shdq ⋆ GA )}{nAW} ) ) ⋆ S mod ) ⋆ H mod$$

where
AqSub=Aquatic substrate composition,
Bdrk=Bedrock component of aquatic substrate,
Bldr=Boulder component of aquatic substrate,
Cb=Cobble component of aquatic substrate,
CCs=Canopy cover of shrub strata,
CCt=Canopy cover of tree strata,
G/C=Gravel/cobble component of aquatic substrate,
GA=Geographic aspect,
Hmod=Habitat type modifier,
IPDpth=Inundation predominant depth,
MMi=Man-made impervious component of aquatic substrate,
MMp=Man-made pervious component of aquatic substrate,
nAW=Number of adjacent habitat types (wetland and/or aquatic, value=1 or 2),
NNveg=Non-native vegetation modifier,
OH2O=Open water,
Org=Organic component of aquatic substrate,
Rk=Rock component of aquatic substrate,
S=Seeps,
S/C=Silt/clay component of aquatic substrate,
Shda=Riparian shade for adjacent aquatic map unit,
Shdw=Riparian shade for adjacent wetland map unit,
Smod=Seep modifier,
Snd=Sand component of aquatic substrate,
TAqVeg=Total aquatic vegetation cover,
TR=Temperature regulation function score, and
U=Unknown component of aquatic substrate.

Variable Velocity (VV)

Function Applies to All Habitat Types (Except Still Water) that are Located within OHW

### Modifiers

Function habitat type modifiers (Hmod)
   Intermittent & ephemeral=0.5
   All other habitat types=1
Channel incision modifier (CImod)

$$If \frac{CI}{OHWh} \geq 1.5 CI mod = 0.5$$

Otherwise=1
Non-native vegetation modifier (NNveg)
   Geomean of non-native emergent cover, non-native submergent cover, and non-native floating mat cover using the following values for each stratum
      Layer not present=1
      All native=1
      <10%=1
      10-30%=0.9
      30-60%=0.8
      60-90%=0.7
      >90%=0.6

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{MUa}$$

Floodplain access (FpA)
   If floodplain access=“constrained”, then FpA=0
      else

$$FpA = ( \frac{OHWw}{WW} )$$

Flowing Water Aquatic Habitat Types

$$( \frac{( \begin{matrix}LWV + MDpth + UcB + bldrs + \\ ( TAqVeg ⋆ NNveg ) + ( FpA ⋆ CI mod )\end{matrix} )}{6} ) ⋆ H mod$$

All Remaining Habitat Types (Except Still Water)

$$( \frac{GCh + GCs + GCt + ( TAqVeg ⋆ NNveg )}{4} ) ⋆ H mod$$

where
Bldr=Boulder component of aquatic substrate,
CI=Channel incision depth,
CImod=Channel incision modifier,
FpA=Floodplain access,
GCh=Ground cover herbaceous strata,
GCs=Ground cover shrub strata,
GCt=Ground cover tree strata,
Hmod=Habitat type modifier,
LWV=Large wood volume,
MDpth=Maximum depth,
MUa=Map unit area (ft),
nLWD=Number of large wood pieces by diameter and length class,
NNveg=Non-native vegetation modifier,
nRW=Number of large wood pieces with an attached rootwad by diameter and size class,
OHWh=Ordinary high water height,
OHWw=Ordinary high water width,
RW=Rootwad,
TAqVeg=Total aquatic vegetation cover,
UcB=Undercut banks,
Vlu=Large wood volume from lookup table,
Vtot=Total volume of large wood,
VV=Variable velocity function score, and
WW=Wetted width.

Amphibian/Turtle Biotic Support

$$( \frac{C / R + F + N / S + H + C}{5} )$$

where
C=Connectivity super-indicator score,
C/R=Cover/refugia super-indicator score,
F=Foraging super-indicator score,
H=Hibernation super-indicator score,
N/S=Nesting/spawning super-indicator score.

Cover/Refugia (C/R):

### Function Applies to All Habitat Types Except Still Water

Still water indicators have not yet been developed

### Modifiers

Habitat type modifier (Hmod)
   Intermittent & ephemeral=0.5
   All other habitat types=1

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{MUa}$$

### Flowing Water Aquatic Habitat Types

$$( \frac{( \frac{OH 2 O + PDpth}{2} ) + TAqVeg + LWV + UcB}{4} ) ⋆ H mod$$

Wetland Habitat Types (with Permanent Inundation)

$$( ( \frac{\begin{matrix}( \frac{\begin{matrix}( nDW + nDWc ) + \\ ( DomTerr ⋆ CCt )\end{matrix}}{2} ) + \\ ( GCh + GCs + GCt ) + Iopen\end{matrix}}{3} ) + ( \frac{\frac{OvHa + OvHw}{nAW}}{4} ) ) ⋆ H mod$$

Wetland Habitat Types (with Seasonal Inundation)

$$( ( \frac{\begin{matrix}( \frac{\begin{matrix}( nDW + nDWc ) + \\ ( DomTerr ⋆ CCt )\end{matrix}}{2} ) + \\ ( GCh + GCs + GCt ) + Idur\end{matrix}}{3} ) + ( \frac{\frac{OvHa + OvHw}{nAW}}{4} ) ) ⋆ H mod$$

### All Remaining Habitat Types (Except Still Water)

$$( ( \frac{\begin{matrix}( GCh + GCs + GCt ) + L / D + \\ ( nDW + nDWc ) + SoilDist\end{matrix}}{4} ) + ( \frac{\frac{OvHa + OvHw}{nAW}}{5} ) ) ⋆ H mod$$

where
C/R=Cover/refugia super-indicator score,
CCt=Canopy cover of tree strata,
DomTerr=Dominant terrestrial structure (Large wood recruitment),
GCh=Ground cover herbaceous strata,
GCs=Ground cover shrub strata,
GCt=Ground cover tree strata,
Hmod=Habitat type modifier,
Idur=Duration of inundation,
Iopen=Percent of inundation area with open water,
L/D=Litter/duff,
LWV=Large wood volume,
MUa=Map unit area (ft),
nAW=Number of adjacent habitat types (wetland and/or aquatic, value=1 or 2),
nDW=Number of down wood pieces present,
nDWc=Number of decay classes present in the down wood,
nLWD=Number of large wood pieces by diameter and length class,
nRW=Number of large wood pieces with an attached rootwad by diameter and size class,
OH2O=Open water,
OvHa=Overhanging vegetation (<4′) along the wetted edge of adjacent aquatic map unit,
OvHw=Overhanging vegetation (<4′) along the wetted edge of adjacent wetland map unit,
PDpth=Predominant depth,
RW=Rootwad,
SoilDist=Soil disturbance,
TAqVeg=Total aquatic vegetation cover,
UcB=Undercut banks,
Vlu=Large wood volume from lookup table, and
Vtot=Total volume of large wood.

Foraging (F)

### Function Applies to All Habitat Types

Still water indicators have not yet been developed

### Modifiers

Habitat type modifier (Hmod)
   Intermittent & ephemeral=0.5
   All other habitat types=1

### Calculated Indicators

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)

Flowing Water Aquatic Habitat Types

$$( \frac{SH 2 O + TAqVeg + Vwat + AqSub}{4} ) ⋆ H mod$$

Wetland Habitat Types

$$( \frac{\begin{matrix}( GCh + GCs + GCt ) + \\ ( nDW + nDWc ) + WatReg + Micro\end{matrix}}{4} ) ⋆ H mod$$

All Remaining Habitat Types (Except Still Water)

$$( \frac{\begin{matrix}( GCh + GCs + GCt ) + \\ SoilDist + L / D + ( nDW + nDWc )\end{matrix}}{4} ) ⋆ H mod$$

where
AqSub=Aquatic substrate composition,
Bdrk=Bedrock component of aquatic substrate,
Bldr=Boulder component of aquatic substrate,
Cb=Cobble component of aquatic substrate,
F=Foraging super-indicator score,
G/C=Gravel/cobble component of aquatic substrate,
GCh=Ground cover herbaceous strata,
GCs=Ground cover shrub strata,
GCt=Ground cover tree strata,
Hmod=Habitat type modifier,
L/D=Litter/duff,
LWV=Large wood volume,
Micro=Microtopography,
MMi=Man-made impervious component of aquatic substrate,
MMp=Man-made pervious component of aquatic substrate,
MUa=Map unit area (ft),
nDW=Number of down wood pieces present,
nDWc=Number of decay classes present in the down wood,
nLWD=Number of large wood pieces by diameter and length class,
nRW=Number of large wood pieces with an attached rootwad by diameter and size class,
Org=Organic component of aquatic substrate,
Rk=Rock component of aquatic substrate,
RW=Rootwad,
S/C=Silt/clay component of aquatic substrate,
SH2O=Open water <4′ deep,
Snd=Sand component of aquatic substrate,
SoilDist=Soil disturbance,
TAqVeg=Total aquatic vegetation cover,
U=Unknown component of aquatic substrate,
Vlu=Large wood volume from lookup table,
Vtot=Total volume of large wood,
Vwat=Water velocity, and
WatReg=Associated water regime.

Nesting/Spawning (N/S)

### Function Applies to All Habitat Types

Still water indicators have not yet been developed

### Modifiers

Habitat type modifier (Hmod)
   Intermittent & ephemeral=0.5
   All other habitat types=1

### Calculated Indicators

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)
Soil substrate composition (SSub)
   The soil substrate performance indicator is calculated by summing the scores for the individual substrate categories present within the map unit. The maximum score for this indicator is 100%.

Ssub=(SOrg+SS/C+SSnd+SG/C+SCb+SRk+SBldr+SBdrk+SMMp+SMMI+SU)

### Flowing Water Aquatic Habitat Types

$$( \frac{PDpth + ( \frac{Em\_veg + Sub\_veg}{2} ) + Vwat + AqSub}{4} ) ⋆ H mod$$

### Wetland Habitat Types

$$( \frac{Wat Reg + IPDpth + Em\_veg + Vwat}{4} ) ⋆ H mod$$

### All Remaining Habitat Types (Except Still Water)

$$( \frac{( nDW + nDWc ) + SSub + GCtot + SoilDist}{4} ) ⋆ H mod$$

where
AqSub=Aquatic substrate composition,
Bdrk=Bedrock component of aquatic substrate,
Bldr=Boulder component of aquatic substrate,
Cb=Cobble component of aquatic substrate,
Em_veg=Emergent vegetation cover,
G/C=Gravel/cobble component of aquatic substrate,
GCtot=Total ground cover,
Hmod=Habitat type modifier,
IPDpth=Predominant depth of inundation,
MMi=Man-made impervious component of aquatic substrate,
MMp=Man-made pervious component of aquatic substrate,
N/S=Nesting/spawning super-indicator score,
nDW=Number of down wood pieces present,
nDWc=Number of decay classes present in the down wood,
Org=Organic component of aquatic substrate,
PDpth=Predominant depth,
Rk=Rock component of aquatic substrate,
S/C=Silt/clay component of aquatic substrate,
SBdrk=Bedrock component of soil substrate,
SBldr=Boulder component of soil substrate,
SCb=Cobble component of soil substrate,
SG/C=Gravel/cobble component of soil substrate,
SMMi=Man-made impervious component of soil substrate,
SMMp=Man-made pervious component of soil substrate,
Snd=Sand component of aquatic substrate,
SoilDist=Soil disturbance,
SOrg=Organic component of soil substrate,
SRk=Rock component of soil substrate,
SS/C=Silt/clay component of soil substrate,
SSnd=Sand component of soil substrate,
SSub=Soil substrate composition,
SU=Unknown component of soil substrate,
Sub_veg=Submergent vegetation cover,
U=Unknown component of aquatic substrate,
Vwat=Water velocity, and
WatReg=Associated water regime.

Hibernation (H)

### Function Applies to All Habitat Types

Still water indicators have not yet been developed

### Modifiers

Habitat type modifier (Hmod)
   Intermittent & ephemeral=0.5
   All other habitat types=1

### Calculated Indicators

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)
Soil substrate composition (SSub)
   The soil substrate performance indicator is calculated by summing the scores for the individual substrate categories present within the map unit. The maximum score for this indicator is 100%.

Ssub=(SOrg+SS/C+SSnd+SG/C+SCb+SRk+SBldr+SBdrk+SMMp+SMMI+SU)

Flowing Water Aquatic Habitat Types

$$( \frac{MDpth + AqSub}{2} ) ⋆ H mod$$

Wetland Habitat Types

$$( \frac{SSub + ( nDW + nDWc}{2} ) ⋆ H mod$$

### All Remaining Habitat Types (Except Still Water)

$$( \frac{SSub + ( nDW + nDWc ) + L / D}{3} ) ⋆ H mod$$

where
AqSub=Aquatic substrate composition,
Bdrk=Bedrock component of aquatic substrate,
Bldr=Boulder component of aquatic substrate,
Cb=Cobble component of aquatic substrate,
G/C=Gravel/cobble component of aquatic substrate,
H=Hibernation super-indicator score,
Hmod=Habitat type modifier,
L/D=Litter/duff,
MDpth=Maximum depth,
MMi=Man-made impervious component of aquatic substrate,
MMp=Man-made pervious component of aquatic substrate,
N/S=Nesting/spawning super-indicator score,
nDW=Number of down wood pieces present,
nDWc=Number of decay classes present in the down wood,
Org=Organic component of aquatic substrate,
Rk=Rock component of aquatic substrate,
S/C=Silt/clay component of aquatic substrate,
SBdrk=Bedrock component of soil substrate,
SBldr=Boulder component of soil substrate,
SCb=Cobble component of soil substrate,
SG/C=Gravel/cobble component of soil substrate,
SMMi=Man-made impervious component of soil substrate,
SMMp=Man-made pervious component of soil substrate,
Snd=Sand component of aquatic substrate,
SOrg=Organic component of soil substrate,
SRk=Rock component of soil substrate,
SS/C=Silt/clay component of soil substrate,
SSnd=Sand component of soil substrate,
SSub=Soil substrate composition,
SU=Unknown component of soil substrate, and
U=Unknown component of aquatic substrate.

Connectivity (C)

### Function Applies to Flowing Water Aquatic Habitat Types Only

Still water indicators have not yet been developed

### Modifiers

Habitat type modifier (Hmod)
   Intermittent & ephemeral=0.5
   All other habitat types=1

All Habitat Types (Except Still Water)

$$( \frac{C / R + C / Ra}{2} ) ⋆ H mod$$

where
C=Connectivity super-indicator score,
C/R=Cover/refugia super-indicator score for the map unit,
C/Ra=Highest cover/refugia super-indicator score of adjacent map units, and
Hmod=Habitat type modifier.

Anadromous Fish Biotic Support

$$( \frac{C / R + F + N / S + C}{4} ) ⋆ FP$$

### Modifiers

Fish passage modifier (FP)
   Applies only to aquatic habitat types
      Map unit is a partial fish passage barrier=0.5
      Map unit is a full passage barrier=0
      Map unit is above a partial fish passage barrier=0.5
      Map unit is above a full passage barrier=0
      Map unit is not above a passage barrier=1

where
C=Connectivity super-indicator score,
C/R=Cover/refugia super-indicator score,
F=Foraging super-indicator score,
FP=Fish passage modifier, and
N/S=Nesting/spawning super-indicator score.

Cover/Refugia (C/R):

### Function Applies to All Qualifying Habitat Types

Stream reach must have been part of historic range
   Aquatic-related, Terrestrial, Urban, and Agricultural habitat types must be adjacent to stream and or wetland within OHW

### Modifiers

Habitat type modifier (Hmod)
   Canal, culvert, ditch, fish passage=0.05
   Intermittent & ephemeral=0.5
   All other habitat types=1
Non-native vegetation modifier (NNveg)
   Geomean of non-native emergent cover, non-native submergent cover, and non-native floating mat cover using the following values for each stratum
      Layer not present=1
      All native=1
      <10%=1
      10-30%=0.9
      30-60%=0.8
      60-90%=0.7
      >90%=0.6

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{MUa}$$

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)

### Flowing Water Aquatic Habitat Types:

$$( \frac{LWV + DAq + ( \frac{\begin{matrix}UcB + AqSub + \\ ( TAqVeg \times NNveg )\end{matrix}}{3} ) + PDpth}{4} ) ⋆ H mod$$

Wetland and Still Water Aquatic Habitat Types:

$$( \frac{\begin{matrix}( nDW + nDWc ) + \\ ( TAqVeg \times NNveg )\end{matrix}}{2} + ( \frac{\frac{OvHa + OvHw}{nAW}}{3} ) ) ⋆ H mod$$

All Remaining Habitat Types:

$$( \frac{OvHa + OvHw}{nAW} ) ⋆ H mod$$

where
AqSub=Aquatic substrate composition,
Bdrk=Bedrock component of aquatic substrate,
Bldr=Boulder component of aquatic substrate,
C/R=Cover/refugia super-indicator score,
Cb=Cobble component of aquatic substrate,
DAq=Dominant aquatic structure,
G/C=Gravel/cobble component of aquatic substrate,
Hmod=Habitat type modifier,
LWV=Large wood volume,
MMi=Man-made impervious component of aquatic substrate,
MMp=Man-made pervious component of aquatic substrate,
MUa=Map unit area (ft),
nAW=Number of adjacent habitat types (wetland and/or aquatic, value=1 or 2),
nDW=Number of down wood pieces present,
nDWc=Number of decay classes present in the down wood,
nLWD=Number of large wood pieces by diameter and length class,
NNveg=Non-native vegetation modifier,
nRW=Number of large wood pieces with an attached rootwad by diameter and size class,
Org=Organic component of aquatic substrate,
OvHa=Overhanging vegetation (<4′) along the wetted edge of adjacent aquatic map unit,
OvHw=Overhanging vegetation (<4′) along the wetted edge of adjacent wetland map unit,
PDpth=Predominant depth,
Rk=Rock component of aquatic substrate,
RW=Rootwad,
S/C=Silt/clay component of aquatic substrate,
Snd=Sand component of aquatic substrate,
TAqVeg=Total aquatic vegetation cover,
U=Unknown component of aquatic substrate,
UcB=Undercut banks,
Vlu=Large wood volume from lookup table, and
Vtot=Total volume of large wood.

Foraging (F)

### Function Applies to All Qualifying Habitat Types

Stream reach must have been part of historic range
   Aquatic-related, Terrestrial, Urban, and Agricultural habitat types must be adjacent to stream and or wetland within OHW

### Modifiers

Habitat type modifier (Hmod)
   Canal, culvert, ditch, fish passage structure=0.05
   Lake, reservoir, constructed pond, open pit=0.10
   Intermittent & ephemeral=0.5
   All other habitat types=1
Non-native vegetation modifier (NNveg)
   Geomean of non-native emergent cover, non-native submergent cover, and non-native floating mat cover using the following values for each stratum
      Layer not present=1
      All native=1
      <10%=1
      10-30%=0.9
      30-60%=0.8
      60-90%=0.7
      >90%=0.6

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{MUa}$$

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)

Flowing Water Aquatic Habitat Types

$$( \frac{LWV + ( TAqVeg \times NNveg ) + PDpth + UcB + AqSub}{5} ) ⋆ H mod$$

Wetland and Still Water Aquatic Habitat Types

$$( ( \frac{\begin{matrix}S H 2 O + Iseasarea + \\ Iseasdur + ( TAqVeg \times NNveg )\end{matrix}}{4} ) + ( \frac{( \frac{Ovha + Ovhw}{nAW} )}{5} ) ) ⋆ H mod$$

All Remaining Habitat Types

$$( \frac{OvHa + OvHw}{nAW} ) ⋆ H mod$$

where
AqSub=Aquatic substrate composition,
Bdrk=Bedrock component of aquatic substrate,
Bldr=Boulder component of aquatic substrate,
Cb=Cobble component of aquatic substrate,
F=Foraging super-indicator score,
G/C=Gravel/cobble component of aquatic substrate,
Hmod=Habitat type modifier,
Iseasarea=Percent area of seasonal inundation,
Iseasdur=Duration of seasonal inundation,
LWV=Large wood volume,
MMi=Man-made impervious component of aquatic substrate,
MMp=Man-made pervious component of aquatic substrate,
MUa=Map unit area (ft),
nAW=Number of adjacent habitat types (wetland and/or aquatic, value=1 or 2),
nLWD=Number of large wood pieces by diameter and length class,
NNveg=Non-native vegetation modifier,
nRW=Number of large wood pieces with an attached rootwad by diameter and size class,
Org=Organic component of aquatic substrate,
OvHa=Overhanging vegetation (<4′) along the wetted edge of adjacent aquatic map unit,
OvHw=Overhanging vegetation (<4′) along the wetted edge of adjacent wetland map unit,
PDpth=Predominant depth,
Rk=Rock component of aquatic substrate,
RW=Rootwad,
S/C=Silt/clay component of aquatic substrate,
SH2O=Open water <4′ deep,
Snd=Sand component of aquatic substrate,
TAqVeg=Total aquatic vegetation cover,
U=Unknown component of aquatic substrate,
UcB=Undercut banks,
Vlu=Large wood volume from lookup table, and
Vtot=Total volume of large wood.

Nesting/Spawning (N/S)

### Function Applies to Flowing Water Aquatic Habitat Types Only

Stream reach must have historically had spawning gravels

### Modifiers

Habitat type modifier (Hmod)
   Canal, culvert, ditch, fish passage=0.05
   Intermittent & ephemeral=0.5
   All other habitat types=1

### Calculated Indicators

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)

Flowing Water Aquatic Habitat Types Only:

$$( \frac{AqSub + ( \frac{AqGR + MDpth}{2} )}{2} ) ⋆ H mod$$

where
AqGR=Gradient (slope) of the water surface,
AqSub=Aquatic substrate composition,
Bdrk=Bedrock component of aquatic substrate,
Bldr=Boulder component of aquatic substrate,
Cb=Cobble component of aquatic substrate,
G/C=Gravel/cobble component of aquatic substrate,
Hmod=Habitat type modifier,
MDpth=Maximum depth,
MMi=Man-made impervious component of aquatic substrate,
MMp=Man-made pervious component of aquatic substrate,
N/S=Nesting/spawning super-indicator score,
Org=Organic component of aquatic substrate,
Rk=Rock component of aquatic substrate,
S/C=Silt/clay component of aquatic substrate,
Snd=Sand component of aquatic substrate, and
U=Unknown component of aquatic substrate.

Connectivity (C)

### Function Applies to Flowing Water Aquatic Habitat Types Only

Stream reach must have been part of historic range

### Modifiers

Habitat type modifier (Hmod)
   Intermittent & ephemeral=0.5
   All other habitat types=1
Length of constraint>200 ft, Connectivity (C)=0
Predominant pool depth (PPDpth)
   <6′=1
   6-10′=0.5
   10-12′=0.25
   >12′=0

### Calculated Indicators

Depth to height ratio (DHr)

$$DHr = ( \frac{MDpth\_dstrm}{FFh} )$$

Bank width constraint

$$B W C = ( \frac{{OHW}_{w}}{BFw} )$$

### All Flowing Aquatic Habitat Types Not Identified as a Man-Made Constraint or Barrier

(1)*H mod

### All Man-Made Constraint and Barrier Flowing Water Habitat Types

$$( \frac{( DHr ⋆ PPDpth ) + MDpth + Vwat + B W C}{4} ) ⋆ H mod$$

where
BFw=Bank-full width,
BWC=Bank width constraint,
C=Connectivity super-indicator score,
DHr=Depth to height ration,
FFh=Free-fall height,
Hmod=Habitat type modifier,
MDpth=Maximum depth,
MDpth_dstrm=Maximum depth of the downstream map unit,
OHWw=Ordinary high water width,
PPDpth=Predominant pool depth at outfall, and
Vwat=Water velocity.

Insect/Invertebrate Biotic Support (II)

$$( \frac{C \text{/} R + N \text{/} S}{2} )$$

where
C/R=Cover/refugia super-indicator score
N/S=Nesting/spawning super-indicator score

Cover/Refugia

### Function Applies to All Habitat Types Except Still Water

### Modifiers

Habitat type modifier (Hmod)
   Intermittent & ephemeral=0.5
   All other habitat types=1

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + * ( Vlu ⋆ ( nRW ⋆ 0.1 ) )}{M U a}$$

Aquatic substrate composition without boulder component (AqSubc)
   The aquatic substrate performance indicator is calculated by summing the scores for the individual substrate categories present within the map unit. The maximum score for this indicator is 100%.
      Aquatic substrate equation does not include boulders (Bldr) as it is scored separately.

AqSubc=(Org+S/C+Snd+G/C+Cb+Rk+Bdrk+MMp+MMi+U)
Soil substrate composition (SSub)
   The soil substrate performance indicator is calculated by summing the scores for the individual substrate categories present within the map unit. The maximum score for this indicator is 100%.

Ssub=(SOrg+SS/C+SSnd+SG/C+SCb+SRk+SBldr+SBdrk+SMMp+SMMI+SU)

Flowing Water Aquatic Habitat Types

$$( \frac{L W V + TAqVeg + Bldr + AqSubc + UcB}{5} ) ⋆ H mod$$

Wetland Habitat Types

$$( ( \frac{\begin{matrix}SSub + CCs + L / D + \\ ( nDw + nDWc )\end{matrix}}{4} ) + ( \frac{( \frac{OvHa + OvHw}{nAW} )}{5} ) ) ⋆ H mod$$

All Remaining Habitat Types (Except Still Water)

$$( \frac{SSub + ( \frac{OvHa + OvHw}{nAW} ) + L \text{/} D + ( nDW + nDWc )}{4} ) ⋆ H mod$$

where
AqSubc=Aquatic substrate composition without boulders component,
Bdrk=Bedrock component of aquatic substrate,
Bldr=Boulder component of aquatic substrate,
CCs=Canopy cover of shrub strata,
C/R=Cover/refugia super-indicator score,
Cb=Cobble component of aquatic substrate,
G/C=Gravel/cobble component of aquatic substrate,
Hmod=Habitat type modifier,
L/D=Litter/duff,
LWV=Large wood volume,
MMi=Man-made impervious component of aquatic substrate,
MMp=Man-made pervious component of aquatic substrate,
MUa=Map unit area (ft),
nAW=Number of adjacent habitat types (wetland and/or aquatic, value=1 or 2),
nDW=Number of down wood pieces present,
nDWc=Number of decay classes present in the down wood,
nLWD=Number of large wood pieces by diameter and length class,
nRW=Number of large wood pieces with an attached rootwad by diameter and size class,
Org=Organic component of aquatic substrate,
OvHa=Overhanging vegetation (<4′) along the wetted edge of adjacent aquatic map unit,
OvHw=Overhanging vegetation (<4′) along the wetted edge of adjacent wetland map unit,
Rk=Rock component of aquatic substrate,
RW=Rootwad,
S/C=Silt/clay component of aquatic substrate,
SBdrk=Bedrock component of soil substrate,
SBldr=Boulder component of soil substrate,
SCb=Cobble component of soil substrate,
SG/C=Gravel/cobble component of soil substrate,
SMMi=Man-made impervious component of soil substrate,
SMMp=Man-made pervious component of soil substrate,
Snd=Sand component of aquatic substrate,
SOrg=Organic component of soil substrate,
SRk=Rock component of soil substrate,
SS/C=Silt/clay component of soil substrate,
SSnd=Sand component of soil substrate,
SSub=Soil substrate composition,
SU=Unknown component of soil substrate,
TAqVeg=Total aquatic vegetation cover,
U=Unknown component of aquatic substrate,
UcB=Undercut banks,
Vlu=Large wood volume from lookup table, and
Vtot=Total volume of large wood.

Nesting/Spawning (N/S)

### Function Applies to All Habitat Types Except Still Water

### Modifiers

Habitat type modifier (Hmod)
   Intermittent & ephemeral=0.5
   All other habitat types=1

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{M U a}$$

Aquatic substrate composition (AqSub)
   The aquatic substrate performance indicator is calculated by summing the scores for the individual substrate categories present within the map unit. The maximum score for this indicator is 100%.

AqSub=(Org+S/C+Snd+G/C+Cb+Rk+Bldr+Bdrk+MMp+MMi+U)
Soil substrate composition (SSub)
   The soil substrate performance indicator is calculated by summing the scores for the individual substrate categories present within the map unit. The maximum score for this indicator is 100%.

Ssub=(SOrg+SS/C+SSnd+SG/C+SCb+SRk+SBldr+SBdrk+SMMp+SMMI+SU)

### Flowing Water Aquatic Habitat Types

$$( \frac{L W V + AqSub}{2} ) ⋆ H mod$$

All Remaining Habitat Types (Except Still Water)

$$( \frac{SSub + L \text{/} D + ( nDW + nDWc )}{3} ) ⋆ H mod$$

where
AqSubc=Aquatic substrate composition without boulders component,
Bdrk=Bedrock component of aquatic substrate,
Bldr=Boulder component of aquatic substrate,
N/S=Nesting/spawning super-indicator score,
Cb=Cobble component of aquatic substrate,
G/C=Gravel/cobble component of aquatic substrate,
Hmod=Habitat type modifier,
L/D=Litter/duff,
LWV=Large wood volume,
MMi=Man-made impervious component of aquatic substrate,
MMp=Man-made pervious component of aquatic substrate,
MUa=Map unit area (ft),
nDW=Number of down wood pieces present,
nDWc=Number of decay classes present in the down wood,
nLWD=Number of large wood pieces by diameter and length class,
nRW=Number of large wood pieces with an attached rootwad by diameter and size class,
Org=Organic component of aquatic substrate,
Rk=Rock component of aquatic substrate,
RW=Rootwad,
S/C=Silt/clay component of aquatic substrate,
SBdrk=Bedrock component of soil substrate,
SBldr=Boulder component of soil substrate,
SCb=Cobble component of soil substrate,
SG/C=Gravel/cobble component of soil substrate,
SMMi=Man-made impervious component of soil substrate,
SMMp=Man-made pervious component of soil substrate,
Snd=Sand component of aquatic substrate,
SOrg=Organic component of soil substrate,
SRk=Rock component of soil substrate,
SS/C=Silt/clay component of soil substrate,
SSnd=Sand component of soil substrate,
SSub=Soil substrate composition,
SU=Unknown component of soil substrate,
U=Unknown component of aquatic substrate,
Vlu=Large wood volume from lookup table, and
Vtot=Total volume of large wood.

Resident Fish Biotic Support (RF)

$$( \frac{C \text{/} R + F + N \text{/} S + C}{4} ) ⋆ FP$$

### Modifiers

Fish passage modifier (FP)
   Applies only to aquatic habitat types
      Map unit is a partial fish passage barrier=0.5
      Map unit is a full passage barrier=0
      Map unit is above a partial fish passage barrier=0.5
      Map unit is above a full passage barrier=0
      Map unit is not above a passage barrier=1

where
C=Connectivity super-indicator score,
C/R=Cover/refugia super-indicator score,
F=Foraging super-indicator score,
FP=Fish passage modifier, and
N/S=Nesting/spawning super-indicator score.

Cover/Refugia (C/R):

### Function Applies to All Qualifying Habitat Types

Aquatic-related, Terrestrial, Urban, and Agricultural habitat types must be adjacent to stream and or wetland within OHW

### Modifiers

Habitat type modifier (Hmod)
   Canal, culvert, ditch, fish passage=0.05
   Man-made aquatic habitat types=0.1
   Intermittent & ephemeral=0.5
   All other habitat types=1
Non-native vegetation modifier (NNveg)
   Geomean of non-native emergent cover, non-native submergent cover, and non-native floating mat cover using the following values for each stratum
      Layer not present=1
      All native=1
      <10%=1
      10-30%=0.9
      30-60%=0.8
      60-90%=0.7
      >90%=0.6

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu ⋆ nLWD ) + ( Vlu ⋆ ( nRW ⋆ 0.1 ) )}{M U a}$$

### Flowing Water Aquatic Habitat Types:

$$( \frac{L W V + ( \frac{\begin{matrix}UcB + AqSubn + \\ ( TAqVeg \times NNveg )\end{matrix}}{3} ) + PDepth}{3} ) * H mod$$

### Wetland and Still Water Aquatic Habitat Types:

$$( \frac{\begin{matrix}( nDW + nDWc ) + \\ ( TAqVeg \times NNveg )\end{matrix}}{2} + ( \frac{\frac{OvHa + OvHw}{nAW}}{3} ) ) * H mod$$

### All Remaining Habitat Types:

$$( \frac{OvHa + OvHw}{nAW} ) * H mod$$

where
AqSubn=Number of aquatic substrate types present,
C/R=Cover/refugia super-indicator score,
Hmod=Habitat type modifier,
LWV=Large wood volume,
MUa=Map unit area (ft),
nAW=Number of adjacent habitat types (wetland and/or aquatic, value=1 or 2),
nDW=Number of down wood pieces present,
nDWc=Number of decay classes present in the down wood,
nLWD=Number of large wood pieces by diameter and length class,
NNveg=Non-native vegetation modifier,
nRW=Number of large wood pieces with an attached rootwad by diameter and size class,
OvHa=Overhanging vegetation (<4′) along the wetted edge of adjacent aquatic map unit,
OvHw=Overhanging vegetation (<4′) along the wetted edge of adjacent wetland map unit,
PDpth=Predominant depth,
RW=Rootwad,
TAqVeg=Total aquatic vegetation cover,
UcB=Undercut banks,
Vlu=Large wood volume from lookup table, and
Vtot=Total volume of large wood.

Foraging (F)

### Function Applies to All Habitat Types

Stream reach must have been part of historic range
   Aquatic-related, Terrestrial, Urban, and Agricultural habitat types must be adjacent to stream and or wetland within OHW

### Modifiers

Habitat type modifier (Hmod)
   Canal, culvert, ditch, fish passage structure=0.05
   Man-made aquatic habitat types=0.10
   Intermittent & ephemeral=0.5
   All other habitat types=1
Non-native vegetation modifier (NNveg)
   Geomean of non-native emergent cover, non-native submergent cover, and non-native floating mat cover using the following values for each stratum
      Layer not present=1
      All native=1
      <10%=1
      10-30%=0.9
      30-60%=0.8
      60-90%=0.7
      >90%=0.6

### Calculated Indicators

Large wood volume calculation (LWV)
   The large wood volume performance indicator is based on the scores in the lookup table for median volumes by diameter and length classes. The volumes (V) in the table were calculated using the equation for the volume of a cylinder, with the midpoint of the diameter divided by 2 used for the radius (r) and the midpoint of the length classes as the height (h). This volume (Vlu) is multiplied by the number of pieces for each specific category and modified according to the number of attached rootwads for each category. A 10% volume bonus is given for each attached rootwad. The volume for each length and diameter class plus any rootwad bonus are summed and divided by the total area of the map unit (in feet) to give the total volume (Vtot in ft³/ft²). This value is used with the lookup tables to get LWV score that is used in the final equations.
      Equation for the volume of a cylinder

V=πr²h
Total volume equation

$$Vtot = \frac{\sum ( Vlu * nLWD ) + ( Vlu * ( nRW * 0.1 ) )}{M U a}$$

Flowing Water Aquatic Habitat Types

$$( \frac{L W V + ( TAqVeg \times NNveg ) + PDpth + UcB + AqSubn}{5} ) * H mod$$

Wetland and Still Water Aquatic Habitat Types

$$( ( \frac{\begin{matrix}SH 2 O + Iseasarea + \\ ( TAqVeg \times NNveg )\end{matrix}}{3} ) + ( \frac{( \frac{OvHa + OvHw}{nAW} )}{4} ) ) * H mod$$

All Remaining Habitat Types

$$( \frac{OvHa + OvHw}{nAW} ) * H mod$$

where
AqSubn=Number of aquatic substrate types present,
F=Foraging super-indicator score,
Hmod=Habitat type modifier,
Iseasarea=Percent area of seasonal inundation,
Iseasdur=Duration of seasonal inundation,
LWV=Large wood volume,
MUa=Map unit area (ft),
nAW=Number of adjacent habitat types (wetland and/or aquatic, value=1 or 2),
nLWD=Number of large wood pieces by diameter and length class,
NNveg=Non-native vegetation modifier,
nRW=Number of large wood pieces with an attached rootwad by diameter and size class,
OvHa=Overhanging vegetation (<4′) along the wetted edge of adjacent aquatic map unit,
OvHw=Overhanging vegetation (<4′) along the wetted edge of adjacent wetland map unit,
PDpth=Predominant depth,
RW=Rootwad,
SH2O=Open water <4′ deep,
TAqVeg=Total aquatic vegetation cover,
UcB=Undercut banks,
Vlu=Large wood volume from lookup table, and
Vtot=Total volume of large wood.

Nesting/Spawning (N/S)

### Function Applies to Aquatic and Wetland Habitat Types Only

### Modifiers

Habitat type modifier (Hmod)
   Canal, culvert, ditch, fish passage=0.05
   Man-made aquatic habitat types=0.1
   Intermittent & ephemeral=0.5
   All other habitat types=1

Flowing Water Aquatic Habitat Types

$$( \frac{AqSubn + ( \frac{AqGR + MDpth}{2} )}{2} ) * H mod$$

Wetland and Still Water Aquatic Habitat Types

$$( \frac{SH 20 + ( TAqVeg * NNveg ) + AqSubn}{3} ) * H mod$$

where
AqGR=Gradient (slope) of the water surface,
AqSubn=Number of aquatic substrate types present,
Hmod=Habitat type modifier,
MDpth=Maximum depth,
N/S=Nesting/spawning super-indicator score,
NNveg=Non-native vegetation modifier, and
TAqVeg=Total aquatic vegetation cover.

Connectivity (C)

### Function Applies to Flowing Water Aquatic Habitat Types and Wetlands

### Modifiers

Habitat type modifier (Hmod)
   Intermittent & ephemeral=0.5
   All other habitat types=1
Length of constraint>200 ft, Connectivity (C)=0
Predominant pool depth (PPDpth)
   <6′=1
   6-10′=0.5
   10-12′=0.25
   >12′=0

### Calculated Indicators

Depth to height ratio (DHr)

$$DHr = ( \frac{MDpth\_dstrm}{FFh} )$$

Bank width constraint

$$B W C = ( \frac{OHWw}{BFw} )$$

All Flowing Aquatic Habitat Types Not Identified as a Man-Made Constraint or Barrier

(1)*H mod

All Man-Made Constraint and Barrier Flowing Water Habitat Types

$$( \frac{( DHr * PPDpth ) + MDpth + Vwat + B W C}{4} ) * H mod$$

All Wetland and Still Water Natural Aquatic Habitat Types

$$( \frac{C \text{/} R + C \text{/} Ra}{2} ) * H mod$$

where
BFw=Bank-full width,
BWC=Bank width constraint,
C=Connectivity super-indicator score,
C/R=Cover/refugia super-indicator score for the map unit,
C/Ra=Highest cover/refugia super-indicator score of adjacent map units,
DHr=Depth to height ration,
FFh=Free-fall height,
Hmod=Habitat type modifier,
MDpth=Maximum depth,
MDpth_dstrm=Maximum depth of the downstream map unit,
OHWw=Ordinary high water width,
PPDpth=Predominant pool depth at outfall, and
Vwat=Water velocity.

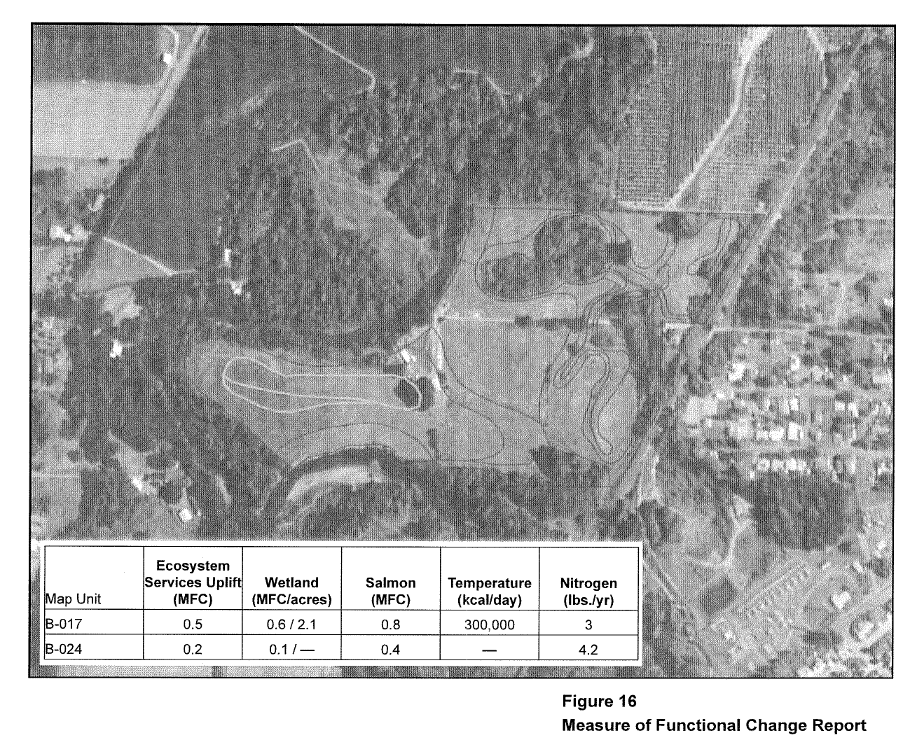

The measure of functional performance at the individual map unit (MFPₘᵤ) can also be calculated (FIG. 16). The MFPₘᵤ at each map unit is a function of the area of the map unit multiplied by the FP′ₘᵤ multiplied by the habitat type (allocated a factor of 1 unless weighted in response to policy decisions regarding priority). Thus, in general the calculation can be expressed as:

MFPₘᵤ=((HTₘᵤ*(X))*(Areaₘᵤ*FP′ₘᵤ))

where
MFPₘᵤ=Measure of Functional Performance (Map Unit),
HTₘᵤ(X)=Habitat Type multiplied by weighting factor. All habitat types have a value of 1 unless policy decisions dictate that one is more valuable than another—at which time the value of 1 is modified (Map Unit),
Areaₘᵤ=area of the individual map unit, normally expressed in acres (Map Unit), and
FP′ₘᵤ=Overall Functional Performance (Map Unit).

The embodiments of the present invention determine the FP′ₘᵤ in the preceding equation according to the following equations:

$$F {P}_{mu}^{′} = \frac{F {P}_{Amu} + F {P}_{Bmu}}{2}$$

$$F {P}_{Amu} = ( \frac{\begin{matrix}C D + S H F + FiL + G W R + HF + InF + \\ N P + NOx + O M P + POx + \\ PoL + S S + SSt + StrSt + T R + V V\end{matrix}}{{n}_{muai}} )$$

$$F {P}_{Bmu} = ( \frac{A F + A T + I I + R F}{{n}_{mubi}} )$$

where
FP′mu=Overall Functional Performance (Map Unit),
FPAmu=Abiotic Function Score (Map Unit),
FPBmu=Biotic Function Score (Map Unit),
nmuai=Number Of Abiotic Functions Performed (Map Unit),
nmubi=Number Of Biotic Functions Performed (Map Unit),
CD=Channel Diversity Function Score (Map Unit),
SHF=Seasonal High Flow Function Score (Map Unit),
FiL=Filtration Function Score (Map Unit),
GWR=Ground Water Recharge Function Score (Map Unit),
HF=Habitat Formation Score (Map Unit),
InF=Infiltration Function Score (Map Unit),
NOx=Nitrogen Removal Function Score (Map Unit),
NP=Natural Plant Succession Function Score (Map Unit),
OMP=Organic Matter Production Function Score (Map Unit),
PoL=Pollination Function Score (Map Unit),
Pox=Phosphorus Retention Function Score (Map Unit),
SS=Spatial Separation Function Score (Map Unit),
SSt=Soil/Substrate Stability Function Score (Map Unit),
StrSt=Streambed Stability Function Score (Map Unit),
TR=Temperature Regulation Function Score (Map Unit),
VV=Variable Velocity Function Score (Map Unit),
AF=Anadromous Fish Biotic Support Score (Map Unit),
AT=Amphibian/Turtle Biotic Support Score (Map Unit),
II=Insect/Invertebrate Biotic Support Score (Map Unit), and
RF=Resident Fish Biotic Support Score (Map Unit).

Last, the summation of the measurements of the functional performance at the map unit level is the measure of functional performance at the site level. This is expressed as:

MFPₛ=ΣMFPₘᵤ

where
MFPₛ=Measure of Functional Performance (Site), and
MFPₘᵤ=Measure of Functional Performance (Map Unit).

The embodiment of the MFPₛ described above can be implemented as a software program executed on a computer.

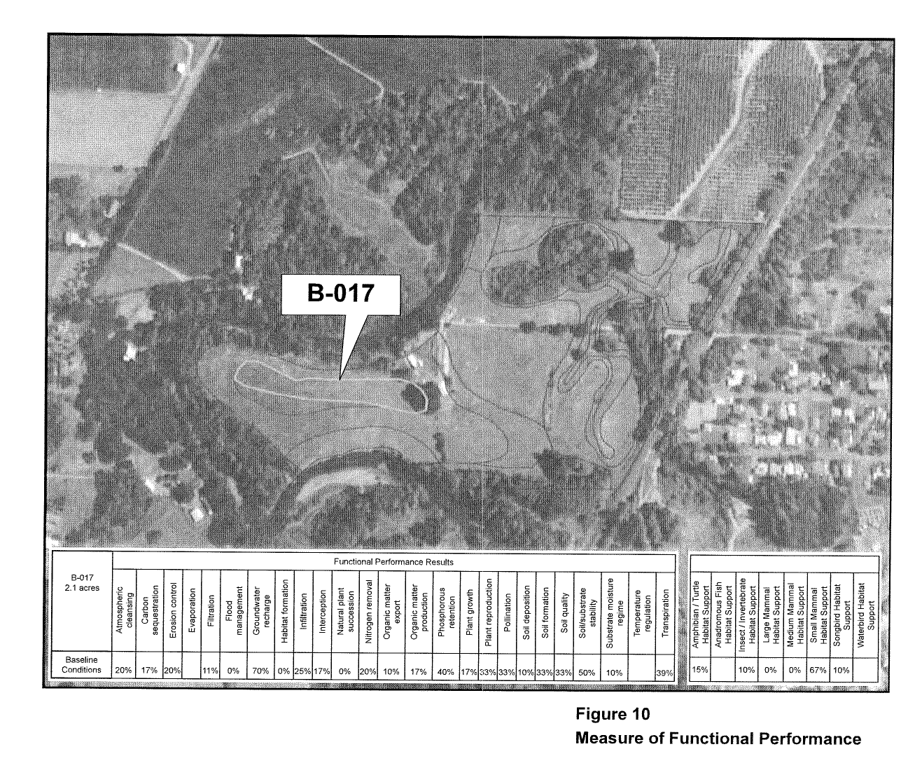

Now referring to FIGS. 9 and 10, and Appendix A, a MFP of a particular map unit B-017 is calculated below to better illustrate the method of the first embodiment of the present invention. Map unit B-017 is an agricultural, unimproved pasture (Section 2B-4 of Appendix A). Such a habitat has functions that include atmospheric cleansing, carbon sequestration, erosion control, filtration, habitat formation, infiltration, interception, nitrogen removal, phosphorous retention, soil formation, transpiration, amphibian/turtle habitat support, and songbird habitat support. Referring to Sections 3 & 4 of Appendix A, indicators are identified and assessed values within statistical ranges. For example, in Section 4B-1 in the section related to water association, the associated water regime is noted as not being present. In the section related to “soils,” the organic surface soil makes up over 90% of the content and silt/clay, sand, gravel/cobble, cobble, and rocks are not present.

For the particular agricultural habitat of B-017 of FIG. 9, functions being performed are determined according to the data collected. For example, soil composition is important as it may aid in drainage. Indicators of soil composition (or ability to absorb moisture) are present within the map unit. Thus, the determination of the soil composition is determined through the data collected as shown on the Field Data Sheets of Appendix A at Section 4A-1 (Soil-substrate/surface characteristics). The various types of soils (e.g., organic, silt/clay, a gravel/cobble mixture, cobble, rocks, boulders, bedrock, etc.) and in the range of percentage present (e.g., not present, less than 5%, 5-10%, 10-30%, 30-60%, 60-90%, and greater than 90% ranges) are recorded. The range present can then be evaluated or scored for the PI value as taken from look-up tables similar to those shown in the Appendix B. These values are generally assigned by professionals in the science field and by panels of biology experts who establish relationships between PI(s) and overall ecological performance. Such information of such indicators can be found in various research data that is generally available and discussed above. Once the PI values are determined for the various functional indicators, the sum of the PI values for a particular function is divided by the number of indicators to determine the FPₘᵤ value.

The MFPₘᵤ is calculated by using the formulas described above. In the example discussed for map unit B-017, for the baseline condition of an unimproved pasture of FIGS. 9 and 10, the PIs related to temperature regulation and temperature credit (measured in kcal/day of solar radiation blocked by radiation) are not scored because no trigger criteria for either function is present. The trigger criteria for temperature regulation in connection with the map unit B-017 would include whether the map unit is an aquatic habitat type, a wetland habitat type with open water present, adjacent to an aquatic map, or adjacent a wetland map containing open water. The trigger criteria for a temperature credit includes whether the map unit is an aquatic habitat type, or whether the map unit is a wetland habitat type with open water present, or whether the map unit is adjacent to an aquatic map unit with open water present. Because the triggering condition for temperature regulation is not met, there is no value calculated for this function. The temperature regulation FP score is also not included in the FP′ score so as not to penalize the map unit because its spatial relationship does not allow the function to be performed.

Similarly, under baseline conditions the evaporation function is not triggered (and, therefore, no calculation) as the map unit is not an aquatic habitat type or a wetland habitat with open water present or adjacent to a map unit that contains either of these two conditions. Again, because the triggering conditions are not satisfied by the data collected for the map unit, FP value for this indicator is not scored, or included in the FP′ score for this map unit.

However, as illustrated in FIG. 10, the FP values have been scored for the functions whose triggering conditions have been met, as determined by the data collected for the map unit. These include atmospheric cleansing (20%), carbon sequestration (17%), erosion control (20%), filtration (11%), habitat formation (0%), infiltration (25%), interception (17%), nitrogen removal (20%), phosphorous retention (40%), soil formation (33%), transpiration (39%), amphibian/turtle habitat support (15%), and songbird habitat support (10%). The FP′ score is obtained by averaging the average FP_{A} and FP_{B} scores and then multiplying by area (here 2.1 acres) and the habitat type of 1.0. or

MFPₘᵤ=((HTₘᵤ*(X))*(Areaₘᵤ*FP′ₘᵤ))

where
FP_{A}=(20%+17%+20%+11%+0%+70%+0%+25%+17%+0%+20%+10%+17%+40%+17%+33%+33%+10%+33%+33%+50%+10%+39%)/23
FP_{A}=23%
FP_{B}=(15%+10%+0%+0%+67%+10%)/6
FP_{b}=17%
FP′=(23%+!7%)/2
FP′=20%
MFPₘᵤ=1×2.1×(20%)
MFPₘᵤ=0.4

The MFPₛ value of the site would be the sum of the individual map unit MFPₘᵤ. Since the conditional value of the site (here, the MFPₘᵤ of the example is 0.4) can be utilized in an economic marketplace or as a measure of some value that can be used in action decision making or for regulatory/policy purposes. The calculation of the present invention generates a measurable unit of ecological condition that can be easily traded or otherwise commercialized in a larger economic marketplace as all values generated by the method will have a similar measure. From this measure, information can also be extracted and presented to regulatory agencies in familiar units when needed (e.g. acreage of a wetland can be extracted from the acreage used to determine the MFP if an agency must use acreage as the basis for permitting).

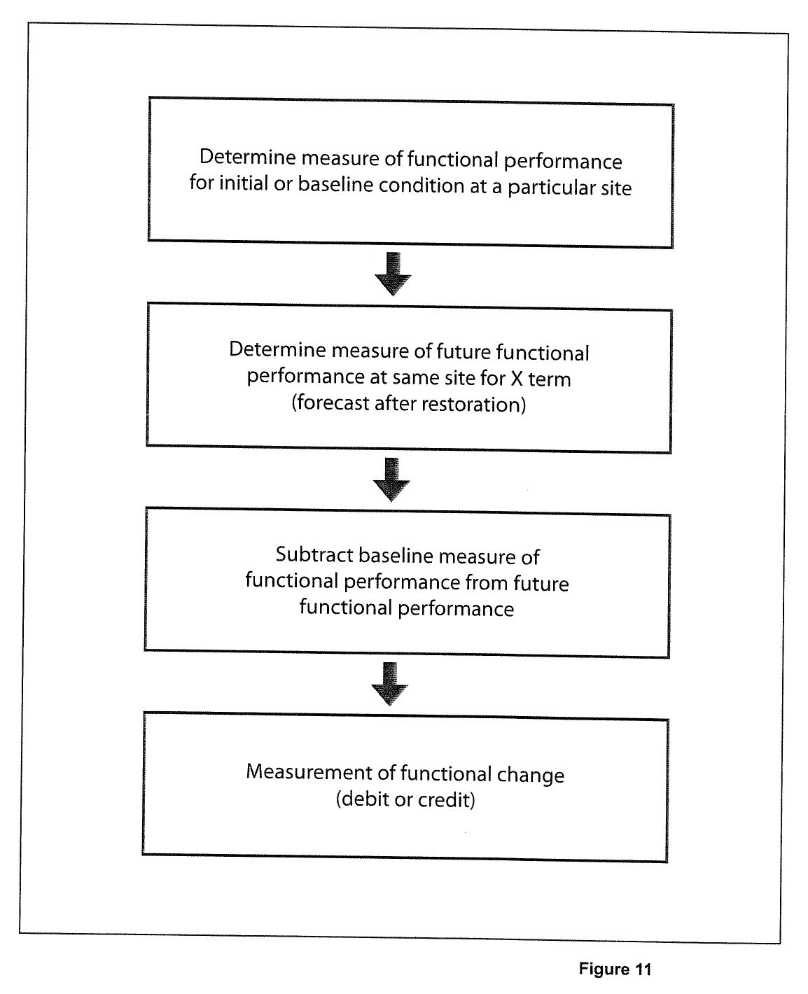

Referring now to FIG. 11, the accounting tool of the present invention also can be used to calculate forecasted change to a particular site. According to the second embodiment of the present invention, the MFPₛ value is also the baseline value measuring ecological conditions or functional performance (MFP_{sb} or MFP baseline). It is the MFP_{sb} that can be compared to the anticipated future MFP_{sf} to determine whether a credit (uplift) or debit (decreased value) has been generated (this could also be done at the map unit level if desired). The difference between the two values can then be used as a number inserted into databases/registries, ecological commodities trading, mitigation banking, or for management/policy/regulatory assessment and action.

Change to a particular site can be measured by creating a future value, as described above for determining the MFP at a site (MFPₛ). The same methodology is used to recalculate the same site at a future time denoted as X in FIG. 11. This future period of time could be evaluated at many different intervals, such as 5, 10, 15, 20 years. The site map is “redrawn” based on some planned development project design, with new relevant habitat functions and physical and biological indicators projected. The Functional Performance for some future time (FP_{f}) is then calculated in the same way as for the FP above but with projected data for the particular future time term (e.g., 20 years out). This can be expressed as:

$$F {P}_{Amuf} = \frac{\sum {PI}_{mufai}}{{n}_{mufai}}$$

$$F {P}_{Bmuf} = \frac{\sum {PI}_{mufbi}}{{n}_{mufbi}}$$

$$F {P}_{muf}^{′} = \frac{F {P}_{Amuf} + F {P}_{Bmuf}}{2}$$

where
FP_{Amuf}=Abiotic Functional Performance (Map Unit Future),
FP_{mufai}=Relevant Abiotic Functional Performance Scores (Map Unit Future),
n_{mufbi}=Number of Relevant Abiotic Functions Performed (Map Unit Future),
FP_{Bmuf}=Biotic Functional Performance (Map Unit Future),
FP_{mufbi}=Relevant Biotic Functional Performance Scores (Map Unit Future),
N_{mufbi}=Number of Relevant Biotic Functions Performed (Map Unit Future), and
FP′_{muf}=Overall Functional Performance (Map Unit Future)

The new measurement of functional performance (future) or MFP_{muf} is also similar to the calculation of MFPₘᵤ above, except the calculation is based on the new habitat type multiplied by the area of the map unit multiplied by the FP′_{muf}. This calculation can be expressed as:

MFP_{muf}=((HT_{muf}*(X))*(Area_{muf}*FP′_{muf}))

where
MFP_{muf}=Measure of Functional Performance (Map Unit Future),
HT_{muf}(X)=Habitat Type multiplied by weighting factor. All habitat types have a value of 1 unless policy decisions dictate that one is more valuable than another—at which time the value of 1 is modified (Map Unit Future),
Area_{muf}=area of the individual map unit, normally expressed in acres (Map Unit Future), and
FP′_{muf}=Overall Functional Performance (Map Unit Future).

Similarly to the calculation of the baseline MFP_{sb}, the functional performance measurement at the future site (MFP_{sf}) is the summation of the individual measurements of functional performance at each future map unit. This can be expressed as:

MFPₛf=ΣMFP_{muf}

where
MFP_{sf}=Measure of Functional Performance (Map Unit Future), and
MFP_{muf}=Measure of Functional Performance (Map Unit Future). Last, the change from between the baseline measurement or value and the future measurement is determined. The measurement of functional change for the site, which is measured either as a credit (uplift) or debit (impact or degradation), can be expressed as:

MFCₛ=MFP_{sf}−MFP_{sb}

where
MFCₛ=Measure of Functional Change (Site Debit or Credit),
MFP_{sf}=Measure of Functional Performance (Site Future), and
MFP_{sb}=Measure of Functional Performance (Site Initial).

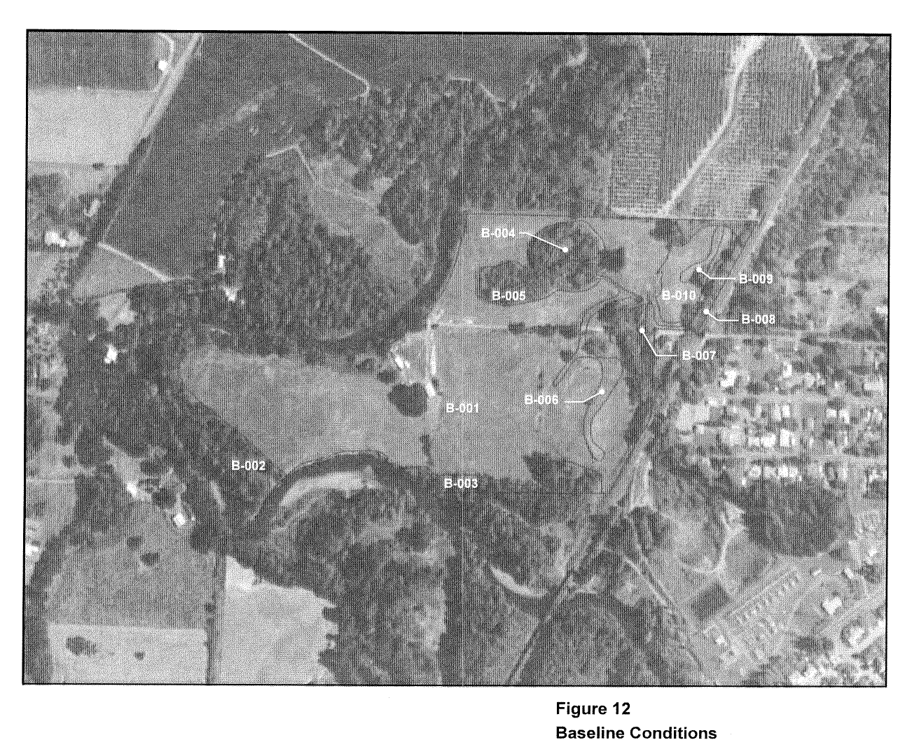

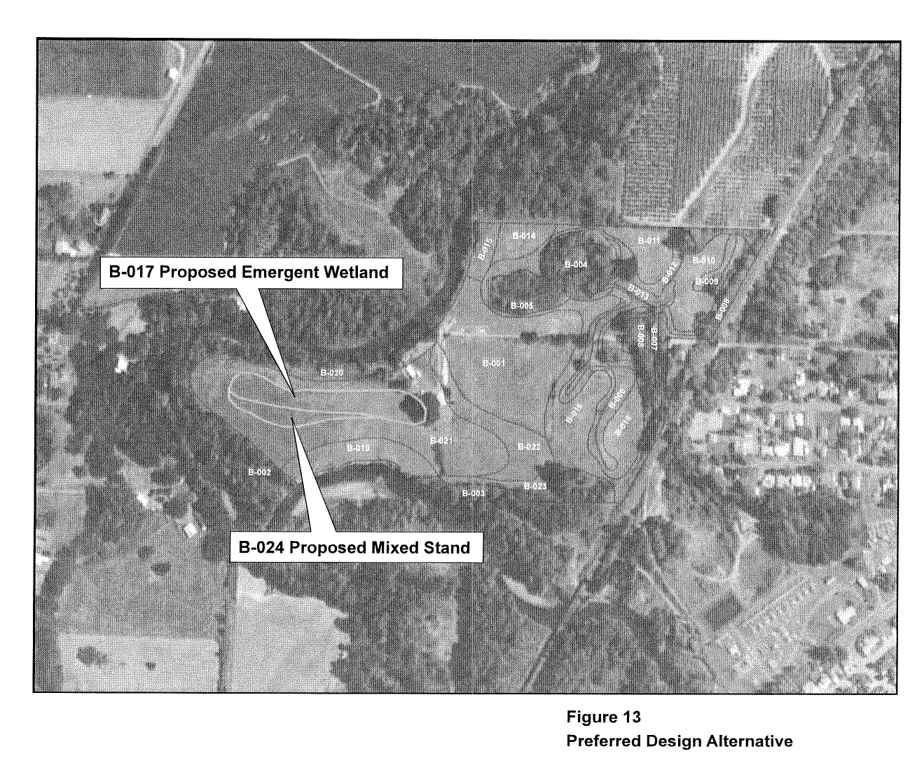

Referring now to FIGS. 12-15, the unimproved pasture of map unit B-017 of the example related to the first embodiment is now adjacent to map unit B-024. Both map units are part of an overall unimproved pasture. The proposed modification for B-017 is creation of an emergent wetland. The proposed modification for B-024 is creation of a mixed tree stand (deciduous and conifers).

Baseline MFPs are calculated the same way as described above, namely, the FP values are scored for the functions whose triggering conditions have been met, as determined by the data collected for the map unit. Here, the field data sheets are attached as Appendix C and D, respectively for the baseline sites. Again, the data does not need to be inputted on paper printouts, but can be entered into (or checked off) a software database that can be accessed through a computer or electronic hand held device.

Individual FP values are assessed, and FP′_{mub} and MFP_{mub} are calculated for each map unit. For the Map Unit B-017, the base line MFP calculation will be the same as before.

MFPₘᵤ=((HTₘᵤ*(X))*(Areaₘᵤ*FP′ₘᵤ))

where
FP_{A}=(20%+17%+20%+11%+0%+70%+0%+25%+17%+0%+20%+10%+17%+40%+17%+33%+33%+10%+33%+33%+50%+10%+39%)/23
FP_{A}=23%
FP_{B}=(15%+10%+0%+0%+67%+10%)/6
FP_{B}=17%
FP′=(23%+!7%)/2
FP′=20%
MFPₘᵤ=1×2.1×(20%)
MFPₘᵤ=0.4

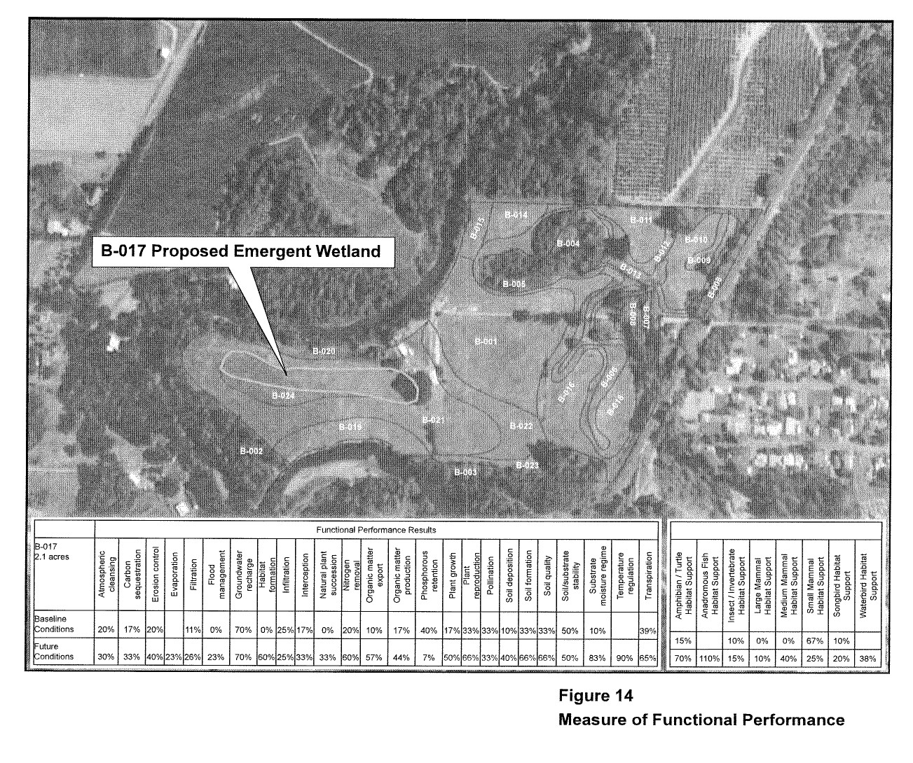

The same process is then redone (including evaluation of the field data) based on the development having been implemented into some projected future time period (e.g., 20 years). Now, the future site has new habitat types (e.g., in B-017 emergent wetland is forecasted as shown in the FP_{muf} values in FIG. 14 such as FP_{muf} for evaporation having a value of 23% where conditions did not trigger the scoring of the function in the baseline map unit). The new FP′ per map unit is obtained by averaging the average FP_{A} and FP_{B} scores and then multiplying by area (here 2.1 acres) and the habitat type of 1.0. or

MFP_{muf}=((HT_{muf}*(X))*(Area_{muf}*FP′_{muf}))

where
FP_{Af}=(30%+33%+40%+23%+26%+23%+70%+60%+25%+33%+33%+60%+57%+44%+7%+50%+66%+33%+40%+66%+66%+50%+83%+90%+65%)/25
FP_{Af}=47%
FP_{Bf}=(70%+110%+15%+10%+40%+25%+20%+38%)/8
FP_{Bf}=41%
FP′_{f}=(47%+41%)/2
FP′_{f}=44%
MFP_{muf}=1×2.1×(44%)
MFP_{muf}=0.9

Note that one FP_{Bf} is scored at greater than 100% (anadromous fish habitat support 110%). This is due to weighting factors that can be applied to the FP equations if policy decisions dictate that one function is more valuable than another.

Once the new MFP_{f} is calculated, the measure of functional change (MFC) is easily arrived at as it is the difference between the future and baseline MFPs).
MFC_{B-017}=MFP_{muf}−MFP_{mub}
or MFC_{B-017}=0.9−0.4=0.5

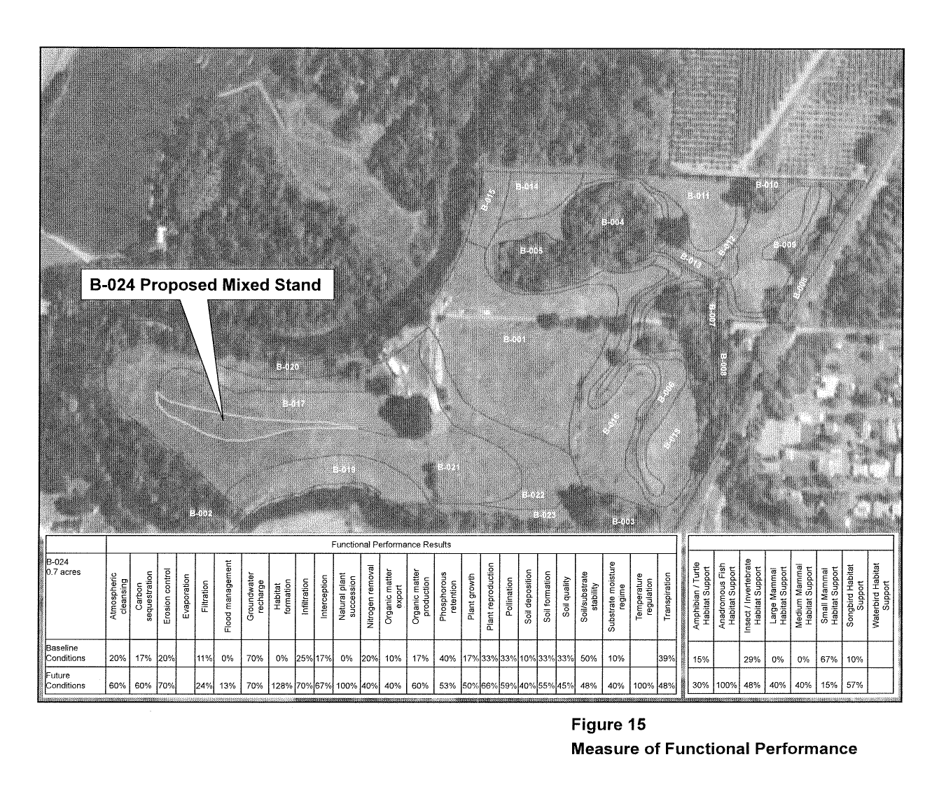

For Map Unit B-024, with an area of 0.7 acre and FPs as shown in FIG. 15 and the data in Appendices A and D, the calculations would be similar:
MFP_{mub}=((1×1)×(0.7))×((((20%+17%+20%+11%+0%+70%+0%+25%+17%+0%+20%+10%+17%+40%+17%+33%+33%+10%+33%+33%+50%+10%+39%)/23)+((15%+29%+0%+0%+67%+10%)/6))/2)
MFP_{mub}=(1×0.7)×(22%))
MFP_{mub}=0.2
MFP_{muf}=((1×1)×(0.7))×((((60%+60%+70%+24%+13%+70%+128%+70%+67%+100%+40%+40%+60%+53%+50%+66%+59%+40%+55%+45%+48%+40%+100%+48%)/24)+((30%+100%+48%+40%+40%+15%+57%)/7))/2)
MFP_{muf}=(1×0.7)×53%)
MFP_{muf}=0.4
MFC_{B-024}=MFP_{muf}−MFP_{mub}
or MFC_{B-024}=0.4−0.2=0.2

Using the MFP for both B-017 and B-024 map units, for both baseline and future values, the resulting MFC for the site would be:
MFP_{sb}(MFP at the site-baseline)=MFP_{mub}(B-017)+MFP_{mub}(B-024)
MFP_{sb}=0.4+0.2
MFP_{sb}=0.6
MFP_{sf}(MFP at the site-future)=MFP_{muf}(B-017)+MFP_{muf}(B-024)
MFP_{sf}=0.9+0.4
MFP_{sf}=1.3
MFCₛ(MFC of the site)=MFP_{sf}−MFP_{sb}
or MFCₛ=1.3−0.6=0.7

This MFC value, which is a credit from converting unimproved pasture to emergent wetland and mixed tree stand, could then be traded in a voluntary marketplace or used in any of the ways identified already above. Further, this value is a unitary metric devoid of any certain denominators that makes trading or selling much easier given that all trades can be readily compared to each other.

Referring also to FIG. 16, and according to another aspect of the present invention, such MFP_{b}, MFP_{f}, and MFC values can be generated into a report. From there, baseline condition reports can be compared to design alternatives to ascertain the amount of anticipated ecological uplift (credit) or impact/degradation (debit) from a particular project.

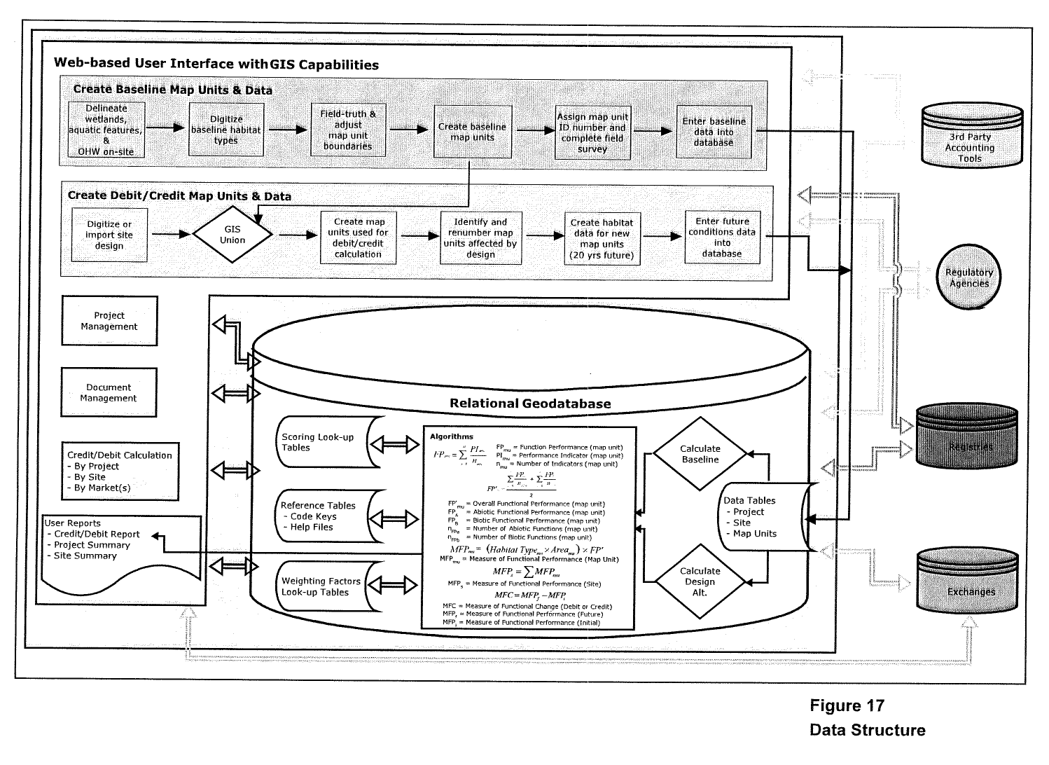

Referring to FIG. 17, the applications of the resulting MFC can be imported into ecological databases, registries, exchanges, or used for regulatory requirements or as a basis for policy making. The resulting MFP of the first embodiment (condition value) can also have the same relationship to external ecological databases, registries, exchanges and the like. Once calculated, the various credits and debits may be independently monitored, verified, and certified to then be used in some form of registry or marketplace or as part of policy and regulatory actions.

Advantages of the present invention include an accounting method that takes physical and biological properties of a particular site into account without cumbersome workarounds, but still manages a balance in obtaining a reasonable range of physical and biological properties/indicators for analysis. Ecological values gained from the accounting method derived from the various embodiments of the invention described above not only provide crucial information about change to a particular site, but also provide good information to regulatory agencies and policy makers. In a voluntary market, the MFC can be sold as a MFC and the benefits to multiple resources can be measured as embedded functions within the overall MFC. In addition to providing a key alternatives analysis decision making tool for use in site design and permitting processes, this invention provides the ability to identify and quantify how a site contributes to the functioning of the ecosystem and how to measure those contributions in discreet units that can be bought or sold in an ecosystem services marketplace. The illustrated embodiments are only examples of the present invention and, therefore, are non-limitive. It is to be understood that many changes in the particular structure, materials, and features of the invention may be made without departing from the spirit and scope of the invention. Therefore, it is the Applicants' intention that their patent rights not be limited by the particular embodiments illustrated and described herein, but rather by the following claims interpreted according to accepted doctrines of claim interpretation, including the Doctrine of Equivalents and Reversal of Parts.

What is claimed is:

1. An accounting method for measuring ecological condition of a particular site, the method comprising:
(a) identifying substantially homogeneous habitats within a particular site and dividing the site into individual map units that correspond to substantially homogeneous habitat types;
(b) collecting data based on physical (abiotic) and biological (biotic) habitat functions of each substantially homogeneous habitat type of the individual map units to ascertain performance indicators (PI) of both abiotic and biotic functions for each map unit;
(c) collecting data for each PI according to defined quantitative and/or qualitative ranges that correspond to look-up tables for both abiotic and biotic functions that contain scoring information for each PI's ability to perform the relevant habitat functions;
(d) scoring each PI via the look-up tables;
(e) calculating abiotic and biotic functional performance values (FP) for each abiotic and biotic habitat function by summing the scores from the look-up tables for each respective type PI and dividing the sum by the number of PIs of the type (abiotic or biotic);
(f) calculating an average abiotic functional performance (FP_{A}) by averaging the abiotic FPs performed by the PIs within each map unit;
(g) calculating an average biotic functional performance (FP_{B}) by functional performance by averaging the abiotic FPs performed by the PIs within each map unit
(h) calculating an overall functional performance value (FP′) for each map unit by averaging the FP_{A} and the FP_{B} of each map unit;
(i) summing the total of each FP′ for each map unit to derive a measure of functional performance value (MFP) of the site.

2. The method according to claim 1 wherein an aerial map of the site is obtained.

3. The method according to claim 1 wherein the look-up tables for performance indicator values are assessed in a numerical range from 0-100% based on statistical curves.

4. The method according to claim 3 wherein the number of incremental units for each performance indicator is determined by repeatability requirements and statistical curves.

5. The method according to claim 2 wherein each aerial map is digitized.

6. The method according to claim 1 wherein field data is inputted into field data sheets broken out by habitat type and performance indicators within statistical ranges.

7. The accounting method according to claim 1 in which the derived measure of functional performance of the site can be utilized in one of the following: a registry, an exchange, or in mitigation banking.

8. The accounting method according to claim 1 in which the a future measure of functional performance is forecasted in the same methodology for the same site but at a future period in which a planned site modification is implemented and that the measurement of functional change is the difference of the measurement of functional performance of the initial unmodified site and the measurement of the future functional performance.

9. The accounting method according to claim 8 wherein the measurement of functional change can be utilized in one of the following: a registry, an exchange, in mitigation banking, or as part of business or government decision/policy making.

10. An accounting method for measuring ecological change of a particular site; the system comprising:
(a) creating a baseline ecological value at a particular site comprising
(i) identifying substantially homogeneous habitats within a particular site and dividing the site into individual map units that correspond to substantially homogeneous habitat types;
(ii) collecting data based on physical (abiotic) and biological (biotic) habitat functions of each substantially homogeneous habitat type of the individual map units to ascertain performance indicators (PI) of both abiotic and biotic functions for each map unit;
(iii) collecting data for each PI according to defined quantitative and/or qualitative ranges that correspond to look-up tables for both abiotic and biotic functions that contain scoring information for each PI's ability to perform the relevant habitat functions;
(iv) scoring each PI via the look-up tables;
(v) calculating abiotic and biotic functional performance values (FP) for each abiotic and biotic habitat function by summing the scores from the look-up tables for each respective type PI and dividing the sum by the number of PIs of the type (abiotic or biotic);
(vi) calculating an average abiotic functional performance (FP_{A}) by averaging the abiotic FPs performed by the PIs with each map unit;
(vii) calculating an average biotic functional performance (FP_{B}) by functional performance by averaging the abiotic FPs performed by the PIs with each map unit
(viii) calculating an overall functional performance value (FP′) for each map unit by averaging the FP_{A} and the FP_{B} of each map unit;
(ix) summing the total of individual FP′ for each map unit to derive a measure of functional performance value (MFP) of the site;
(b) creating an ecological value of a particular site in a set future time based on a future projection after a site modification project has been implemented comprising
(i) identifying substantially homogeneous habitats within a particular site and dividing the site into individual map units that correspond to substantially homogeneous habitat types; all based on planned future condition;
(ii) collecting data based on projected future physical (abiotic) and biological (biotic) habitat functions of each substantially homogeneous habitat type of the future condition individual map units to ascertain future performance indicators (PI_{F}) of both abiotic and biotic functions for each map unit;
(iii) collecting data for each PI_{F} according to defined quantitative and/or qualitative ranges that correspond to look-up tables for both abiotic and biotic functions that contain scoring information for each PI_{F}'s ability to perform the relevant habitat functions;
(iv) scoring each PI_{F} via the look-up tables;
(v) calculating future abiotic and biotic functional performance values (FP_{F}) for each abiotic and biotic habitat function by summing the scores from the look-up tables for each respective type PI_{F} and dividing the sum by the number of PI_{F}s of each future map unit;
(vi) calculating a future average abiotic functional performance (FP_{AF}) by averaging the abiotic FP_{F}s performed by the PI_{F}s within each future map unit;
(vii) calculating a future average biotic functional performance (FP_{BF}) by functional performance by averaging the abiotic FP_{F}s performed by the PI_{F}s with each future map unit
(viii) calculating a future overall functional performance value (FP_{F}′) for each future map unit by averaging the FP_{AF} and the FP_{BF} of each future map unit;
(ix) summing the total of each FP_{F}′ for each future map unit to derive a future measure of functional performance value (MFP_{F}) of the site;
and
(c) calculating the benefit or detriment to the particular site based on the difference between the future measure of functional performance (MFP_{F}) and the baseline measure of functional performance (MFP) to arrive a measurement of functional change (MFC) of a particular site.

11. The accounting method according to claim 10 in which the calculated benefit or detriment value can be utilized in one of the following: a registry, an exchange, or in mitigation banking.

12. The method according to claim 1 wherein the act of collecting data based on abiotic and biotic habitat functions and the quantitative and/or qualitative condition of the PIs present within each map unit is inputted into a computer software database.

13. The method according to claim 1 wherein the lookup tables are a computer database and the step of scoring each PI is via the computerized look-up tables database.

14. The method according to claim 1 wherein calculations and summing steps are implemented through a computer program and the MFP value is recorded in an electronic medium.

15. One or more computer readable storage medium having encoded thereon computer executable instructions for performing a method of measuring ecological condition of a particular site, the method comprising:
(a) identifying substantially homogeneous habitats within a particular site and dividing the site into individual map units that correspond to substantially homogeneous habitat types;
(b) collecting data based on physical (abiotic) and biological (biotic) habitat functions of each substantially homogeneous habitat type of the individual map units to ascertain performance indicators (PI) of both abiotic and biotic functions for each map unit;
(c) collecting data for each PI according to defined quantitative and/or qualitative ranges that correspond to look-up tables for both abiotic and biotic functions that contain scoring information for each PI's ability to perform the relevant habitat functions;
(d) scoring each PI via the look-up tables;
(e) calculating abiotic and biotic functional performance values (FP) for each abiotic and biotic habitat function by summing the scores from the look-up tables for each respective type PI and dividing the sum by the number of PIs within the map unit;
(f) calculating an average abiotic functional performance (FP_{A}) by averaging the abiotic FPs performed by the PIs within each map unit;
(g) calculating an average biotic functional performance (FP_{B}) by functional performance by averaging the abiotic FPs performed by the PIs with each map unit
(h) calculating an overall functional performance value (FP′) for each map unit by averaging the FP_{A} and the FP_{B} of each map unit; and
(i) summing the total of each FP′ for each map unit to derive a measure of functional performance value (MFP) of the site;
